(19) United States
(12) Patent Application Publication
(10) Pub. No.: US 2025/0281938 A1
(43) Pub. Date: Sep. 11, 2025

(54) SPIT REDUCTION FOR FLUID APPLICATORS

(71) Applicant: Wagner Spray Tech Corporation, Plymouth, MN (US)

(72) Inventor: Christopher J. SULZER, St. Louis Park, MN (US)

(21) Appl. No.: 19/032,961

(22) Filed: Jan. 21, 2025

Related U.S. Application Data
(60) Provisional application No. 63/562,986, filed on Mar. 8, 2024.

(51) Int. Cl. B05B 1/30; B05B 9/01; B05B 9/04

(52) U.S. Cl. CPC B05B 1/3046; B05B 9/01; B05B 9/0403

(57) ABSTRACT

A fluid applicator includes a gun having a trigger, a valve assembly moveable in a first direction by actuation of the trigger, a first spring that biases the valve assembly in a second direction and is compressible by movement of the valve assembly in the first direction, and a second spring that stores energy in a first phase of the movement of the valve assembly in the first direction and releases the stored energy in a second phase of the movement of the valve assembly in the first direction. The applicator includes a spray tip assembly having a spray tip, a tip saddle, and a seal element disposed within the tip saddle and having a top surface in contact with an exterior surface of the tip saddle, the seal element defining an inlet to the spray tip assembly and forming a seal between the gun and the spray tip assembly.

### CROSS-REFERENCE TO RELATED APPLICATION

The present application is based on and claims the benefit of U.S. provisional patent application Ser. No. 63/562,986, filed Mar. 8, 2024, the content of which is hereby incorporated by reference in its entirety.

### BACKGROUND

In one example of a fluid application system, a pump receives and pressurizes a fluid, delivers the pressurized fluid to a fluid applicator, which, in turn, applies the pressurized fluid to a surface using a spray tip having a geometry selected to emit a desired spray pattern (e.g., a round pattern, a flat pattern, or a fan pattern, etc.). The fluid may comprise any fluid applied to surfaces, including, but not limited to, for example, paint, primer, lacquers, foams, textured materials, plural components, adhesive components, etc.

One example of a fluid applicator is a spray gun. Spray guns include a gun and a spray tip assembly. The spray gun generally includes an inlet, that receives fluid from a fluid source (e.g., fluid pumped by a pump), and an outlet. A spray tip assembly is coupled to the gun at the outlet of the spray gun. The spray tip assembly includes a spray tip, along with other items. The spray tip includes an inlet, that receives fluid from the gun, and an outlet that releases the fluid in a desired spray pattern, such as a spray fan. The spray tip breaks up, or atomizes, the fluid for delivery in the desired spray pattern. A spray gun can also include a valve that is actuatable, such as by actuation of a trigger of the spray gun, to selectively allow fluid to flow to the spray tip.

While examples described herein are in the context of applying paint to a surface, it is understood that the concepts are not limited to these particular applications. As used herein, paint includes substances composed of coloring matter, or pigments, suspended in a liquid medium as well as substances that are free of coloring matter or pigment. Paint may also include preparatory coatings, such as primers, and can be opaque, transparent, or semi-transparent. Some particular examples include, but are not limited to, latex paint, oil-based paint, stain, lacquers, varnishes, inks, etc.

The discussion above is merely provided for general background information and is not intended to be used as an aid in determining the scope of the claimed subject matter.

### SUMMARY

One example fluid application system includes one or more pumps, a fluid delivery line coupled to the one or more pumps, and a fluid applicator. The fluid applicator includes a gun; and a spray tip assembly removably coupled to the gun. The spray tip assembly includes a spray tip, a tip saddle, and a seal disposed, at least partially, within the tip saddle and having a top surface in contact with an exterior surface of the tip saddle, the seal defining an inlet to the spray tip assembly and forming a seal between the gun and the spray tip assembly. In one example, the spray tip assembly further includes a retaining element, the tip saddle and the spray tip disposed, at least partially, within the retaining element and the seal comprises a captivating wing configured to contact an inner surface of the retaining element and thereby establish a friction fit between the seal and the retaining element. In one example, the seal comprises a hard polymer, such as, but not limited to, nylon.

One example fluid application system includes one or more pumps, a fluid delivery line coupled to the one or more pumps, and a fluid applicator. The fluid applicator includes a spray tip assembly and a gun, removably coupled to the spray tip assembly. The gun includes a trigger; and a valve assembly configured to be moved in a first direction by actuation of the trigger. The valve assembly includes a first spring configured to bias the valve assembly in a second direction and to be compressed by movement of the valve assembly in the first direction; and a second spring configured to store energy in a first phase of the movement of the valve assembly in the first direction of movement and to release the stored energy in a second phase of the movement of the valve assembly in the first direction to assist in moving the valve assembly in the first direction. In one example, the second spring is a compression spring. In one example, the second spring is a tension spring. In one example, both the first spring and the second spring are configured to contact fluid applied by the fluid application system. In one example, the gun further includes a spring chamber, a valve fluid volume, and a seal configured to fluidically seal the spring chamber from the valve fluid volume. In one example, both the first spring and the second spring are disposed in the spring chamber. In one example, the first spring is disposed in the spring chamber and the second spring is disposed in the valve fluid volume. In one example, the second spring is in contact with the trigger.

One example fluid application system includes one or more pumps, a fluid delivery line coupled to the one or more pumps, and a fluid applicator. The fluid applicator includes a gun. The gun includes a trigger; and a valve assembly configured to be moved in a first direction by actuation of the trigger. The valve assembly includes a first spring configured to bias the valve assembly in a second direction and to be compressed by movement of the valve assembly in the first direction; and a second spring configured to store energy in a first phase of the movement of the valve assembly in the first direction of movement and to release the stored energy in a second phase of the movement of the valve assembly in the first direction to assist in moving the valve assembly in the first direction. The fluid applicator includes a spray tip assembly removably coupled to the gun. The spray tip assembly includes a spray tip, a tip saddle, and a seal disposed, at least partially, within the tip saddle and having a top surface in contact with an exterior surface of the tip saddle, the seal defining an inlet to the spray tip assembly and forming a seal between the gun and the spray tip assembly. In one example, the spray tip assembly further includes a retaining element, the tip saddle and the spray tip disposed, at least partially, within the retaining element and the seal comprises a captivating wing configured to contact an inner surface of the retaining element and thereby establish a friction fit between the seal and the retaining element. In one example, the seal comprises a hard polymer, such as, but not limited to, nylon. In one example, the second spring is a compression spring. In one example, the second spring is a tension spring. In one example, both the first spring and the second spring are configured to contact fluid applied by the fluid application system. In one example, the gun further includes a spring chamber, a valve fluid volume, and a seal configured to fluidically seal the spring chamber from the valve fluid volume. In one example, both the first spring and the second spring are disposed in the spring chamber. In one example, the first spring is disposed in the spring chamber and the second spring is disposed in the valve fluid volume. In one example, the second spring is in contact with the trigger.

One example spray tip assembly, configured to be removably coupled to a gun and to emit fluid in a spray pattern, includes a spray tip, a tip saddle, and a seal disposed, at least partially, within the tip saddle and having a top surface in contact with an exterior surface of the tip saddle, the seal defining an inlet to the spray tip assembly and forming a seal between the gun and the spray tip assembly. In one example, the spray tip assembly further includes a retaining element, the tip saddle and the spray tip disposed, at least partially, within the retaining element and the seal comprises a captivating wing configured to contact an inner surface of the retaining element and thereby establish a friction fit between the seal and the retaining element. In one example, the seal comprises a hard polymer, such as, but not limited to, nylon.

One example fluid gun, configured to be removably coupled to a spray tip and to control a flow of fluid to the spray tip, includes a trigger and a valve assembly. The gun includes a trigger; and a valve assembly configured to be moved in a first direction by actuation of the trigger. The valve assembly includes a first spring configured to bias the valve assembly in a second direction and to be compressed by movement of the valve assembly in the first direction; and a second spring configured to store energy in a first phase of the movement of the valve assembly in the first direction of movement and to release the stored energy in a second phase of the movement of the valve assembly in the first direction to assist in moving the valve assembly in the first direction. In one example, the second spring is a compression spring. In one example, the second spring is a tension spring. In one example, both the first spring and the second spring are configured to contact the fluid. In one example, the gun further includes a spring chamber, a valve fluid volume, and a seal configured to fluidically seal the spring chamber from the valve fluid volume. In one example, both the first spring and the second spring are disposed in the spring chamber. In one example, the first spring is disposed in the spring chamber and the second spring is disposed in the valve fluid volume. In one example, the second spring is in contact with the trigger.

One example fluid applicator includes a gun and a spray tip assembly removably coupled to the gun. The spray tip assembly includes a spray tip, a tip saddle, and a seal disposed, at least partially, within the tip saddle and having a top surface in contact with an exterior surface of the tip saddle, the seal defining an inlet to the spray tip assembly and forming a seal between the gun and the spray tip assembly. In one example, the spray tip assembly further includes a retaining element, the tip saddle and the spray tip disposed, at least partially, within the retaining element and the seal comprises a captivating wing configured to contact an inner surface of the retaining element and thereby establish a friction fit between the seal and the retaining element. In one example, the seal comprises a hard polymer, such as, but not limited to, nylon.

One example fluid applicator includes a spray tip assembly and a gun, removably coupled to the spray tip assembly. The gun includes a trigger; and a valve assembly configured to be moved in a first direction by actuation of the trigger. The valve assembly includes a first spring configured to bias the valve assembly in a second direction and to be compressed by movement of the valve assembly in the first direction; and a second spring configured to store energy in a first phase of the movement of the valve assembly in the first direction of movement and to release the stored energy in a second phase of the movement of the valve assembly in the first direction to assist in moving the valve assembly in the first direction. In one example, the second spring is a compression spring. In one example, the second spring is a tension spring. In one example, both the first spring and the second spring are configured to contact fluid applied by the fluid applicator. In one example, the gun further includes a spring chamber, a valve fluid volume, and a seal configured to fluidically seal the spring chamber from the valve fluid volume. In one example, both the first spring and the second spring are disposed in the spring chamber. In one example, the first spring is disposed in the spring chamber and the second spring is disposed in the valve fluid volume. In one example, the second spring is in contact with the trigger.

One example fluid applicator includes a gun. The gun includes a trigger; and a valve assembly configured to be moved in a first direction by actuation of the trigger. The valve assembly includes a first spring configured to bias the valve assembly in a second direction and to be compressed by movement of the valve assembly in the first direction; and a second spring configured to store energy in a first phase of the movement of the valve assembly in the first direction of movement and to release the stored energy in a second phase of the movement of the valve assembly in the first direction to assist in moving the valve assembly in the first direction. The fluid applicator includes a spray tip assembly removably coupled to the gun. The spray tip assembly includes a spray tip, a tip saddle, and a seal disposed, at least partially, within the tip saddle and having a top surface in contact with an exterior surface of the tip saddle, the seal defining an inlet to the spray tip assembly and forming a seal between the gun and the spray tip assembly. In one example, the spray tip assembly further includes a retaining element, the tip saddle and the spray tip disposed, at least partially, within the retaining element and the seal comprises a captivating wing configured to contact an inner surface of the retaining element and thereby establish a friction fit between the seal and the retaining element. In one example, the seal comprises a hard polymer, such as, but not limited to, nylon. In one example, the second spring is a compression spring. In one example, the second spring is a tension spring. In one example, both the first spring and the second spring are configured to contact fluid applied by the fluid applicator. In one example, the gun further includes a spring chamber, a valve fluid volume, and a seal configured to fluidically seal the spring chamber from the valve fluid volume. In one example, both the first spring and the second spring are disposed in the spring chamber. In one example, the first spring is disposed in the spring chamber and the second spring is disposed in the valve fluid volume. In one example, the second spring is in contact with the trigger.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

FIG. 1 is a perspective view showing one example fluid application system.

FIG. 2 is a side view showing one example fluid applicator.

FIG. 3 is a perspective view showing one example spray tip.

FIG. 4 is a partial front view showing one example spray tip.

FIGS. 5A-5C (collectively referred to herein as FIG. 5) are sectional views showing one example fluid applicator.

FIGS. 6A-6C (collectively referred to herein as FIG. 6) are sectional views showing one example fluid applicator.

FIG. 7 is a schematic illustration of one example valve assembly.

FIG. 8 is a graphical illustration.

FIG. 9 is a sectional view showing one example fluid applicator.

FIG. 10 is simplified pictorial illustration showing one example valve assembly.

FIGS. 11A-11B (collectively referred to herein as FIG. 11) are sectional views showing one example fluid applicator.

FIGS. 12A-12B (collectively referred to herein as FIG. 12) are sectional views showing one example fluid applicator.

FIG. 13A is sectional to view showing one example valve assembly.

FIG. 13B is perspective view showing one example valve assembly.

FIG. 14 is a schematic illustration of one example valve assembly.

FIG. 15 is a schematic illustration of one example fluid applicator.

FIG. 16 is a schematic illustration of one example fluid applicator.

FIG. 17 is a schematic illustration of one example fluid applicator.

FIG. 18 is a schematic illustration of one example fluid applicator.

FIG. 19 is a schematic illustration of one example fluid applicator.

FIG. 20 is a block diagram showing one example fluid application system.

### DETAILED DESCRIPTION OF THE DRAWINGS

For the purposes of promoting an understanding of the principles of the present disclosure, reference will now be made to the examples illustrated in the drawings, and specific language will be used to describe the same. It will nevertheless be understood that no limitation of the scope of the disclosure is intended. Any alterations and further modifications to the described devices, systems, methods, and any further application of the principles of the present disclosure are fully contemplated as would normally occur to one skilled in the art to which the disclosure relates. In particular, it is fully contemplated that the features, components, and/or steps described with respect to one example may be combined with the features, components, and/or steps described with respect to other examples of the present disclosure.

As spray guns are activated and deactivated (e.g., as a valve is opened and closed), spitting can occur. Spitting is the expulsion of droplets or uneven bursts of fluid instead of in a smooth and even pattern. Spitting can result in inconsistent finish on the target surface, application of fluid on non-target surfaces, wasted fluid, and additional labor for touch-up. There are two forms of spitting, start spitting (or starting spit) and stop spitting (or stopping spit). Start spitting occurs when the gun is activated (e.g., valve is opened) and results from too slow a pressurization of the fluid volume downstream of the valve (which includes the fluid volume of the spray tip as well as other items). Stop spitting occurs when the gun is deactivated (e.g., valve is closed) and results from too slow a depressurization of the fluid volume downstream of the valve.

A number of factors influence the occurrence and severity of spitting, such as the size of the fluid volume downstream of the valve, how quickly the valve can open and close, the pressure accumulation of the fluid volume downstream of the valve, as well as other factors.

The present description proceeds with example systems and methods for reducing spitting in fluid applicators. The example systems and methods provide for one or more of reducing the size of the fluid volume downstream of the valve (without necessarily reducing the fluid volume of the spray tip), increasing the speed at which the valve can actuate (e.g., open or close, or both), and decreasing the pressure accumulation of the fluid volume downstream of the valve. Each of reducing the size of the fluid volume downstream of the valve, increasing the speed at which the valve can actuate (e.g., open or close, or both), and decreasing the pressure accumulation of the fluid volume downstream of the valve can reduce spitting.

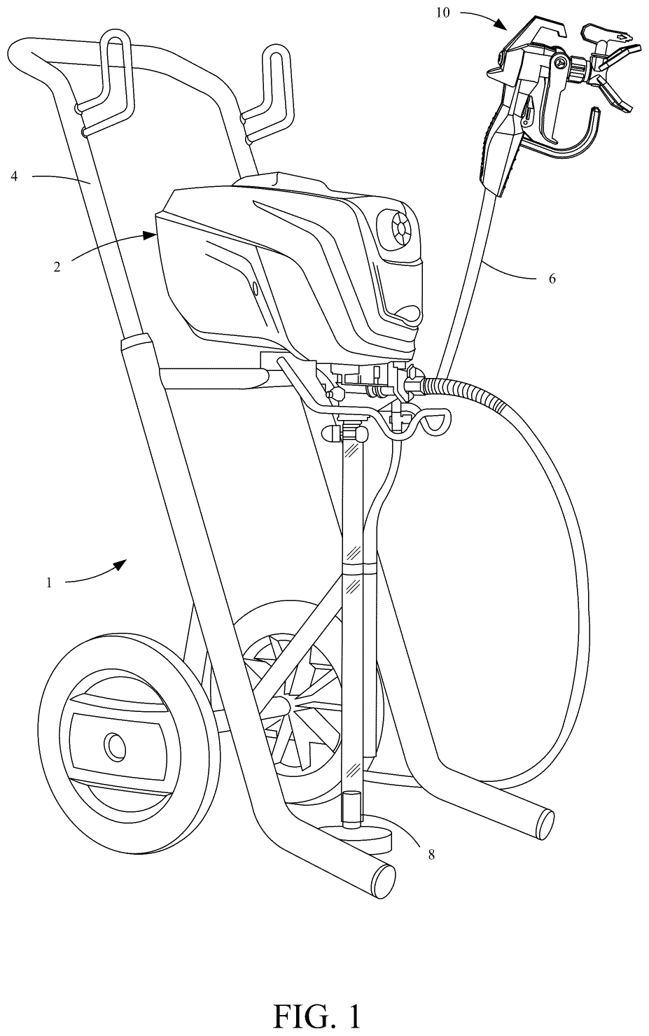

FIG. 1 is a perspective view showing one example fluid application system 1. Fluid application system 1, illustratively shown as an airless fluid spraying system (e.g., a high efficiency airless spraying system), includes pump 2 that is mounted on a cart 4 and couples to applicator 10 through fluid delivery line 6 (e.g., a hose). Pump 2 includes a fluid intake 8 that is disposed within a fluid source (e.g., a five-gallon bucket of paint). Pump 2 pumps the fluid from the fluid source through fluid intake 8 and pumps the fluid at a given pressure to applicator 10 through fluid delivery line 6 (e.g., a flexible hose). In one example, pump 2 can pressurize the fluid between 1500-3500 PSI.

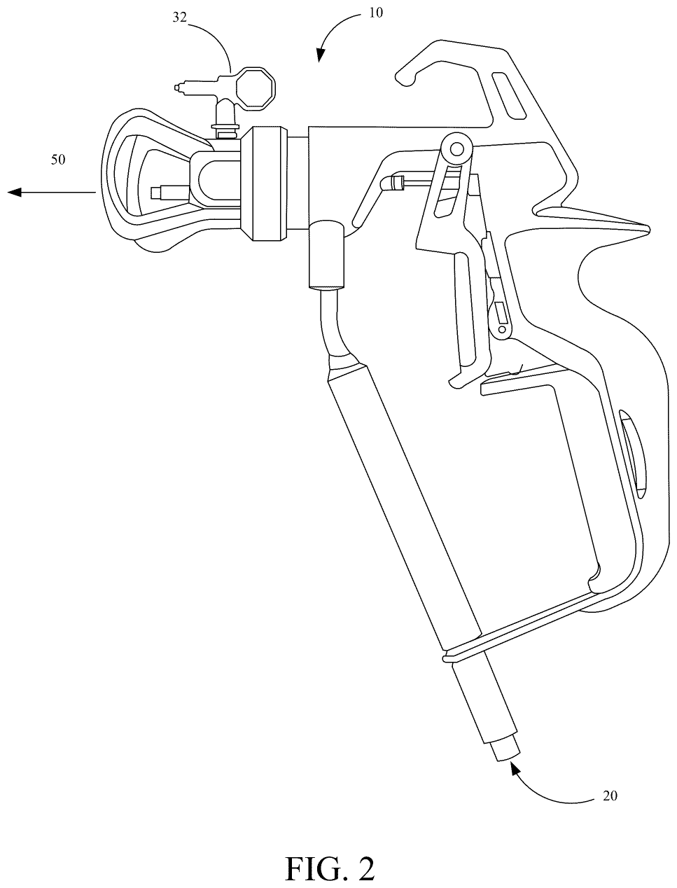

FIG. 2 is a side view showing an example applicator 10. Applicator 10 is used in a fluid spraying system (e.g., fluid application system 1) to apply fluid to a surface (e.g., apply paint to a wall). The fluid enters through inlet 20, and exits from outlet 50, after passing through a fluid channel (not explicitly shown) within applicator 10. Fluid inlet 20 may be coupled to a fluid delivery line, such as fluid delivery line 6. Tip 32 is coupled to applicator 10 and has an outlet 50. Tip 32 often is reversible (e.g., tip 32 can be rotated around its longitudinal axis such that the inlet and outlet are flipped in position (i.e., inlet of tip 32 facing away from applicator 10 and outlet of tip 32 facing towards applicator 10)) or removable from applicator 10. The reversibility of spray tip 32 can help with cleaning.

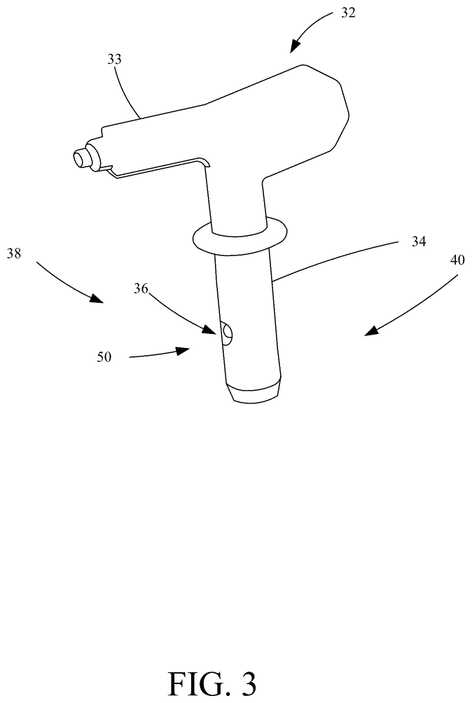

FIG. 3 is a perspective view showing an example spray tip 32. Spray tip 32 includes flag 33, tip stem 34, and receiving channel 36. Flag 33 can be coupled to tip stem 34 in various ways including, for example, but not by limitation, press fitting flag onto tip stem 34 or over molding flag 33 onto tip stem 34. Flag 33 provides a convenient surface for handling spray tip 32, particularly when spray tip 32 is installed in an applicator and can be used to indicate the directionality of spray tip 32. Flag 33 can comprise various materials, for example, polymer. Tip stem 34 can comprise various materials, for example, metal such as stainless steel. A receiving channel 36 can be provided through tip stem 34, such as by machining, cutting, etc. The receiving channel 36 extends a distance between a front 38 of spray tip 32 and a rear (or back) 40 of spray tip 32. In some examples, the receiving channel 36 may extend from a front 38 of spray tip 32 to a rear 40 of spray tip 32 and yet, in other examples, the receiving channel 36 may extend some other distance. The receiving channel 36 will be shown in more detail below.

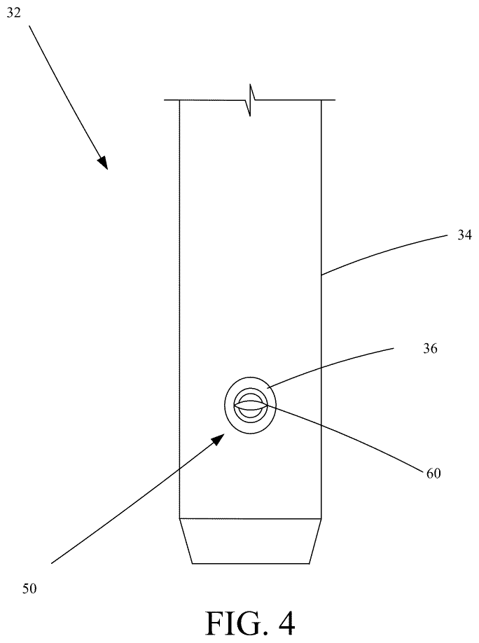

FIG. 4 is a partial front view showing example spray tip 32. As illustrated in FIG. 4, a tip piece 60 can be placed and retained within receiving channel 36. Additionally, as will be shown below, a pre-orifice element can, optionally, be placed in the receiving channel 36. Examples of spray tip 32 are shown below (e.g., spray tip 132 and spray tip 432).

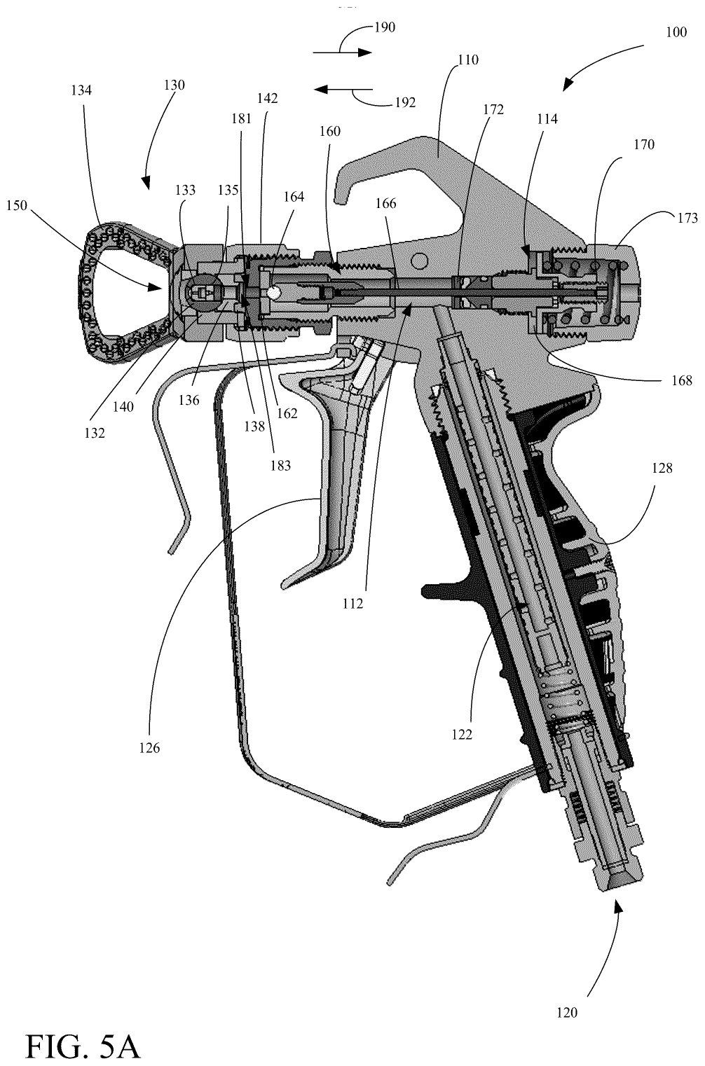

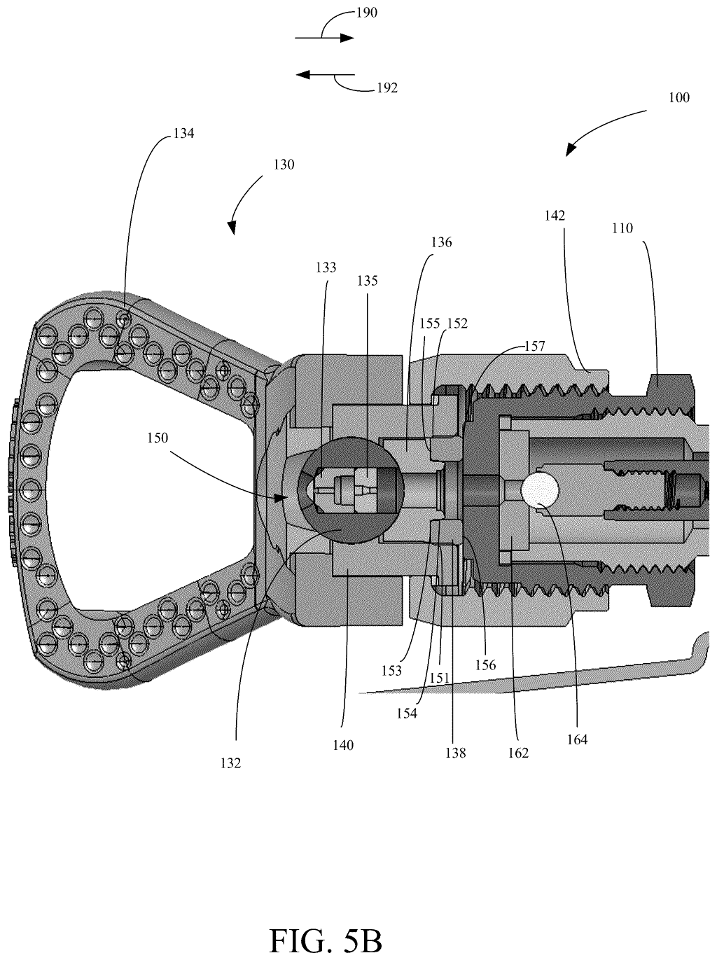

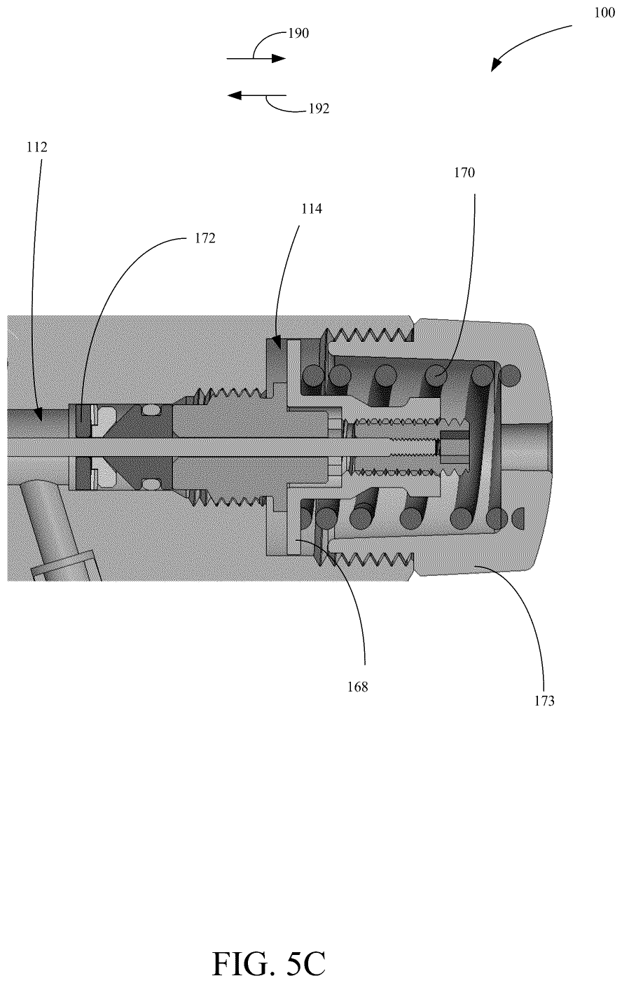

FIGS. 5A-C (collectively referred to herein as FIG. 5) are sectional views showing one example fluid applicator 100, illustratively a spray gun. Fluid applicator 100 can be used in a fluid application system, such as fluid application system 1 shown in FIG. 1, in place of fluid applicator 10.

Spray gun 100 includes gun (or gun body) 110, inlet 120, trigger 126, spray tip assembly 130, outlet 150, Gun 110 includes, among other things, valve fluid volume 112, valve spring chamber 114, inlet fluid volume 122, handle 128, valve assembly 160, outlet 181, and can include various other items.

Inlet 120 is coupled to a delivery line (e.g., 6) and is configured to receive fluid pumped through the delivery line (e.g. 6). Fluid enters gun 110 through inlet 120 and travels through inlet fluid volume 122, disposed within handle 128, to valve fluid volume 112.

Spray tip assembly 130 includes spray tip 132, outlet guard 134, tip saddle 136, seal 138, retaining element 140, and coupling mechanism 142. Spray tip 132 can be similar to and used in place of spray tip 32. Spray tip 132 includes tip piece 133 and pre-orifice piece 135. In other examples, spray tip 132 could include, as a pre-orifice element, a pre-orifice formed in the body of spray tip 132 rather than a pre-orifice element as a separate pre-orifice piece, such as pre-orifice piece 135. In other examples of spray tip 132, a pre-orifice element, such as a pre-orifice piece 135, need not be included. Tip piece 133 defines outlet 150 and is configured to emit fluid in a desired spray pattern. Spray tip 132, tip saddle 136, and seal 138 are disposed within retaining element 140 and are thereby coupled to one another. Spray tip 132 is rotatable (about its longitudinal axis) within retaining element 140 between a normal operating position (shown in FIG. 5, where outlet 150 is facing away from gun 110) and a cleaning operating position (where outlet 150 is facing toward gun 110). Outlet guard 134 is coupled to retaining element 140, such as by a snap-on connection. Coupling mechanism 142 is coupled to retaining element 140, such as by a snap-on connection. Coupling mechanism 142 is also coupled to gun body 110 (threaded connection in the illustrated example) and thereby couples spray tip assembly 130 to gun 110.

Seal 138 creates a seal between gun 110 and spray tip assembly 130. As shown in FIG. 5 (best seen in FIG. 5B), seal 138 includes a top surface 151 in contact with an interior surface 152 of retaining element 140, a downstream surface 153 and a bottom (or interior) surface 154 in contact with an exterior surface 155 of tip saddle 136, and an upstream surface 156 in contact with an exterior surface 157 of gun 110.

Valve assembly (or valve) 160 includes valve seat 162, valve ball 164, valve shaft 166, spring plate 168, spring 170, and seal 172, and can include various other items. Valve assembly 160 is moveable, in the directions 190 and 192, by actuation of the trigger 126 (as described below), between a seated (or closed) position (as shown in FIG. 5) and a plurality of open positions (from initially open to fully open). It will be appreciated by those skilled in the art that there is a range of open positions of valve assembly 160, the range extending between an initial point when valve ball 164 is retracted sufficiently to initially allow some fluid through valve seat 162 to spray tip assembly 130, though the valve ball 164 is still disrupting flow through the valve seat 162, and a fully open (or fully retracted) point in which valve assembly 160 is retracted to the fullest extent and the valve ball 164 is fully pulled away from valve seat 162. In other words, it will be understood that the valve assembly 160 can effectively control the flow rate of fluid to the fluid volume of spray tip assembly 130. Valve ball 164, valve shaft 166, and spring plate 168 are coupled together.

Trigger 126 is moveably coupled to the gun body 110 and is moveable, such as by application and release (or reduction) of force from user's hand, in directions 190 and 192, between a deactivated (or resting) position (shown in FIG. 5) and an activated position. Trigger 126 is coupled to spring plate 168 such that actuation of trigger 126 in the direction 190 causes spring plate 168 to move in the direction 190 and thereby compress spring 170 to open valve assembly 160. When valve assembly 160 is opened, fluid flows from valve fluid volume 112, through seat 162, out of gun outlet 181 to spray tip assembly 130 through spray tip assembly inlet 183.

Spring 170 biases valve assembly 160 in a closed position, and is compressible, as described above, to open valve assembly 160. Hydrostatic pressure of fluid in valve chamber 112 also biases valve 160 in a closed position. The biasing force of the spring 170 and of the hydrostatic pressure can be overcome by application of force to trigger 126.

Seal 172 operably seals spring chamber 114 from valve fluid volume 112. In this way, spring plate 168 and spring 170 are not in contact with fluid, which can improve wear (or longevity) of spring plate 168 and spring 170. Further, the seal between valve fluid volume 112 and spring chamber 114 can even allow for access to spring plate 168 and spring 170, such as for maintenance or replacement, even when the gun 110 is pressurized. As shown, applicator 100 includes a spring chamber cap 173 that is removably coupled (via threaded connection as shown) to gun body 110. Spring chamber cap 173 can be removed to allow access to spring chamber 114. Spring chamber cap 173 also provides a surface against which spring 170 bears to be compressed and against which spring 170 bears to extend.

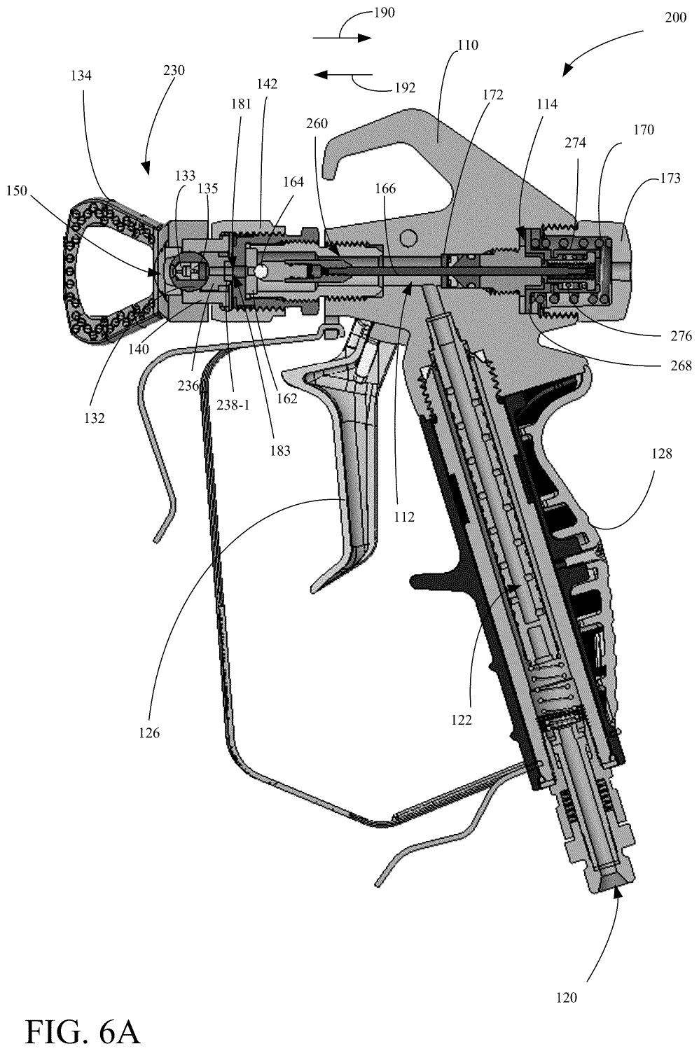

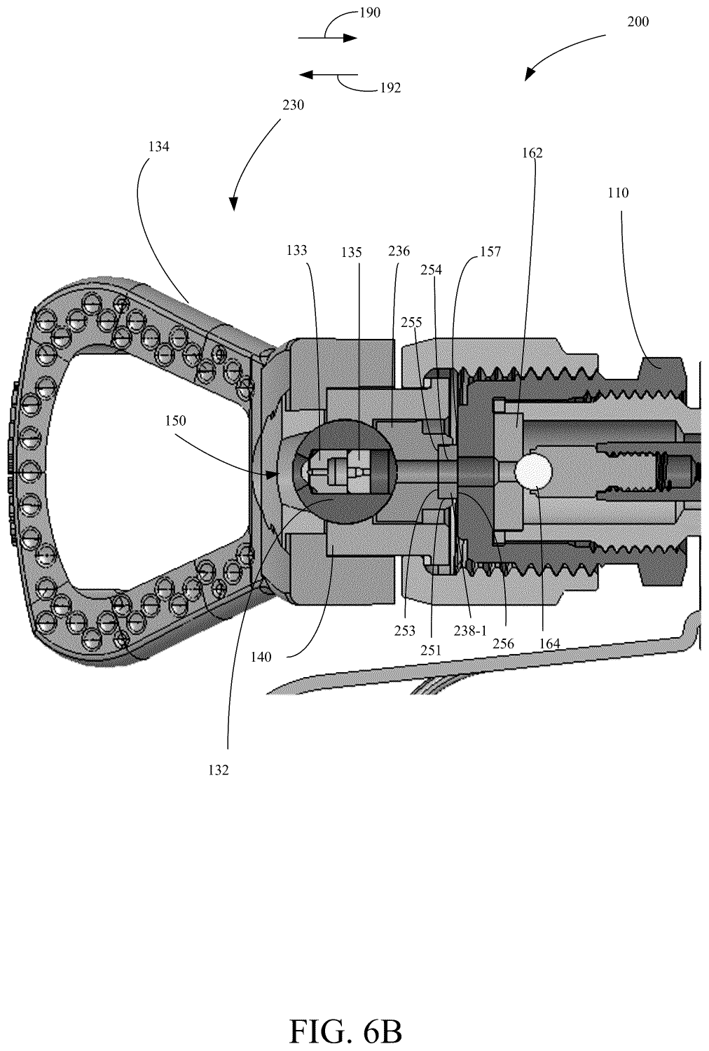

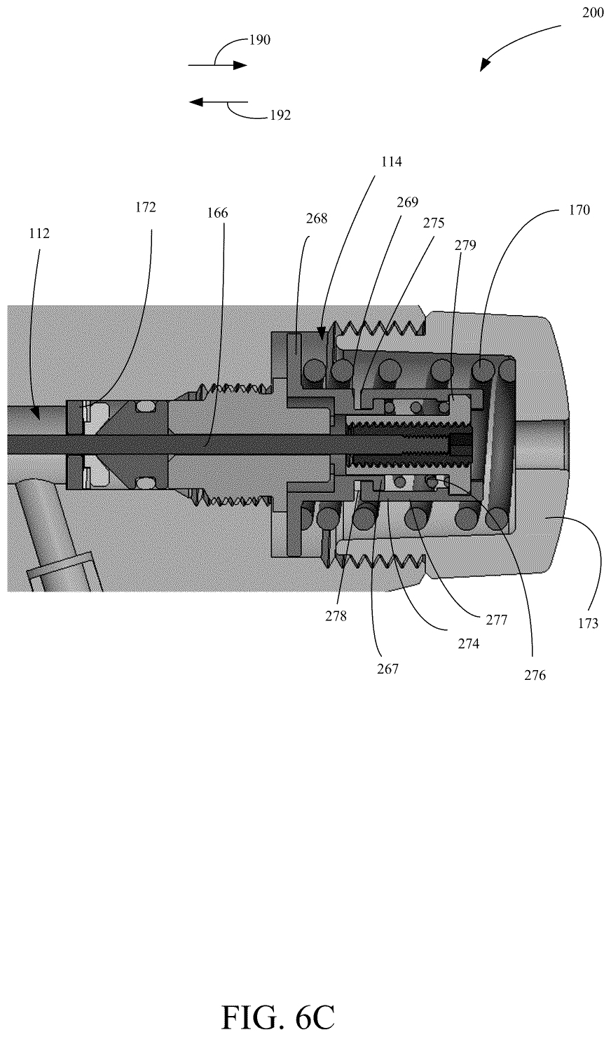

FIGS. 6A-C (collectively referred to herein as FIG. 6) are sectional views showing one example fluid applicator 200, illustratively a spray gun. Fluid applicator 200 can be used in a fluid application system, such as fluid application system 1 shown in FIG. 1, in place of fluid applicator 10. Fluid applicator 200 is similar to fluid applicator 100 shown in FIG. 5 and thus, similar items are numbered similarly.

It can be seen in FIG. 6 that fluid applicator 200 includes a spray tip assembly 230 and a valve assembly 260. Spray tip assembly 230 differs from spray tip assembly 130 in that spray tip assembly 230 includes tip saddle 236 and seal 238 (illustratively 238-1), different from tip saddle 136 and seal 138 of spray tip assembly 130. Valve assembly (or valve) 260 differs from valve assembly (or valve) 160 in that valve assembly 260 includes a spring plate 268, different from spring plate 168, and also includes a spring clip 274 and an additional (or second) spring 276.

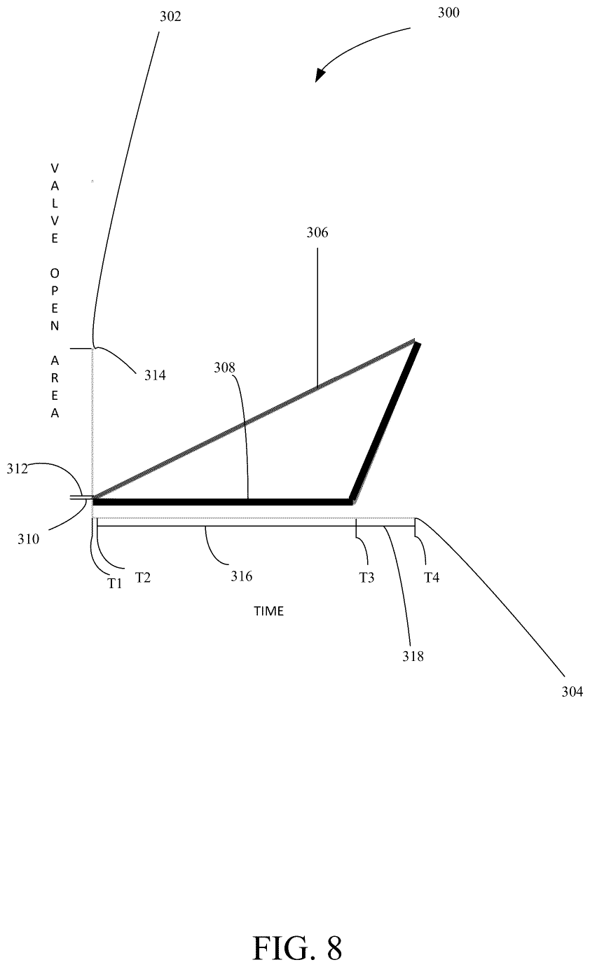

Tip saddle 236 and seal 238 provide for a reduction of the volume downstream of the valve, without changing the spray tip 132 or the tip piece 133 or pre-orifice piece 135, and for a reduction of the pressure accumulation of the volume downstream of the valve. Seal 238 also defines an inlet 283 of spray tip assembly 230. As can be seen in FIG. 6, tip saddle 236 includes a seal-recess (or seal seat) 237 in which seal 238 is disposed. Seal 238, like seal 138, creates a seal between gun 110 and the spray tip assembly. However, seal 238 is of a smaller size (smaller diameter, both interior and exterior diameter) than seal 138. Additionally, the elasticity of the volume downstream of the valve is reduced, and thus the pressure accumulation of the volume downstream of the valve is reduced, by the arrangement of seal 238. As shown, seal 238 includes a top surface 251 in contact with an exterior surface 255 of tip saddle 236. The contact between top surface 251 and exterior surface 255 allows seal 238 to still provide sealing between gun 110 and the spray tip assembly 260, at a smaller size than that of seal 138, while also providing resistance the expansion of seal 238 to reduce or prevent pressure accumulation. Seal 238 also includes a downstream surface 253 in contact with the exterior surface 255 of tip saddle 236. As can be seen, seal 238 also includes an upstream surface 256 in contact with the exterior surface 157 of gun 110. Further, as can be seen, seal 238 includes a bottom (or interior) surface 254 that does not contact another item of spray tip assembly 260 (whereas the bottom surface 154 of seal 138 contacts the exterior surface 155 of tip saddle 136). Another example of seal 238 will be shown in FIG. 8.

The reduced size and reduced pressure accumulation of the volume downstream of the valve assembly 260, will help to reduce spitting, both start spitting and stop spitting. The reduced size and pressure accumulation of the volume downstream of the valve assembly 260 will pressurize more quickly (e.g., more quickly than the volume downstream of the valve assembly 160) and thus reduce start spitting. The reduced size and pressure accumulation of the volume downstream of the valve assembly 260 will depressurize more quickly (e.g., more quickly than the volume downstream of the valve assembly 160) and thus reduce stop spitting.

As shown in FIG. 6, valve assembly 260 includes an additional spring 276 disposed around valve shaft 166 and disposed between spring plate 268 and a spring clip 274. Movement of spring plate 268, in the direction 190, by way of actuation of trigger 126, will, eventually, move spring clip 274, and thus valve shaft 166, in the direction 190.

As can be seen, there is an adjustable gap 278 between spring plate 268 and spring clip 274 that closes with actuation of spring plate 268 in the direction 190. In one example, the gap 278, in a valve closed position (as shown in FIG. 6), is 0.03 inches or 0.75 millimeters. Though, in other examples, the gap 278, in a valve closed position, could be larger or smaller. As spring plate 268 is moved in the direction 190, shoulder 267 of spring plate 268 is moved along wall 277 of spring clip 274, in the direction 190, compressing spring 276 against shoulder 279 of spring clip 274 and storing energy in spring 276. Additionally, spring plate 268, during this initial phase of movement (closing the gap 278 phase), partially compresses spring 170. During this initial phase of movement, the closing of the gap phase, the spring clip 274, and thus the valve shaft 166, remains stationary or, at least, does not move in the direction 190, and the ball 164 is not dislodged from valve seat 162. Thus, it will be understood that that the double spring system shown in FIG. 6 allows for an amount (e.g., 0.03 inches or 0.75 millimeters or other gap sizes) of compression before the valve ball 164 is dislodged from the seat 162. That is, the double spring system shown in FIG. 6 allows for an amount (e.g., 0.03 inches or 0.75 millimeters or other gap sizes) of movement of spring plate 268 before movement of spring clip 274 and thus valve shaft 166 and valve ball 164. Eventually, with continual movement in the direction 190, the gap 278 is closed. In in a subsequent phase of movement, when the gap is closed, such that shoulder 269 of spring plate 268 contacts shoulder 275 of spring clip 274, spring clip 274 will begin moving in the direction 190 and will be assisted in the movement in direction 190 by the stored energy of spring 276 which will assist in opening the valve (unseating the valve ball 164) more quickly. This subsequent phase of movement, wherein the spring 276 releases its stored energy, includes an initial opening of the valve assembly 260 to a fully open position of the valve assembly 260. That is, the valve ball 164 will become dislodged from the valve seat 162 during this subsequent phase.

The initial phase of movement (e.g., closing the gap phase) can also be referred to as the energy storage phase. The subsequent phase of movement can also be referred to as the energy release phase.

The action of the multiple springs shown in FIG. 6, described above, allows the valve assembly 260 to open more quickly, specifically, to open more quickly from initially open to fully open and thereby to pressurize the volume downstream of the valve 260 more quickly. The valve assembly 260 opening more quickly (e.g., more quickly than the valve assembly 160) will help to reduce spitting (e.g., start spitting) by allowing for the volume downstream of the valve to be pressurized more quickly.

Additionally, while the example shown in FIG. 6 shows that a spray gun 200 includes both spray tip assembly 230 and valve assembly 260, it will be understood that in other examples, a spray gun could include one or the other. For example, a spray gun could include spray tip assembly 230 but include a different valve assembly, such as valve assembly 160. In another example, a spray gun could include valve assembly 260 but include a different spray tip assembly, such as spray tip assembly 130. As discussed, the reduced pressure accumulation downstream of the valve, provided by spray tip assembly 230, can reduce spitting and the quicker opening of the valve assembly 260 can reduce spitting.

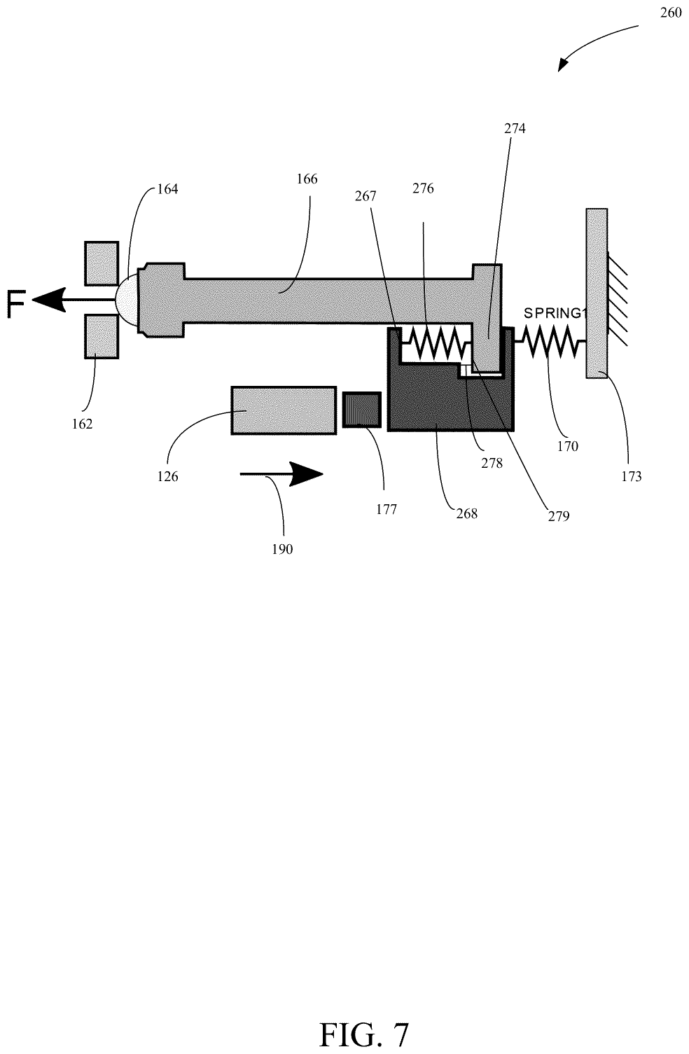

FIG. 7 is a schematic illustration of valve assembly 260. As shown in FIG. 7, actuation of trigger 126 in direction 190 causes spring plate 268 to move in the direction 190. As illustrated in FIG. 7, trigger 126 is coupled to spring plate 268 by way of a coupling mechanism 177. During the initial phase of movement, spring plate 268 compresses spring 170 and spring 276, storing energy in spring 276, until adjustable gap 278 is closed whereby spring plate 268 contacts spring clip 274 and, in a subsequent phase of movement, drives spring clip 274, and thus, valve shaft 166, in the direction 190, opening valve. In the subsequent phase of movement, the stored energy of spring 276 is released and assists in driving spring clip 274, and thus valve shaft 276, in the direction 190 to open the valve more quickly.

FIG. 8 is a graphical illustration showing an improved rate of valve opening provided by the double spring system shown in FIG. 6. As shown in FIG. 8, graph 300 include Y axis 302, X axis 304, line 306, line 308, valve closed 310, valve initial open 312, valve fully open 314, T1, T2, T3, T4, valve opening time 316, and valve opening time 318. Y axis 302 comprises a scale of valve open area values and includes, as shown, three illustrated values of valve closed 310, valve initially open 312, and valve fully open 314. Line 306 corresponds to a valve assembly, such as valve assembly 160, and shows a time it takes the corresponding valve assembly (e.g., 160) to fully open from an initial opening. Line 380 corresponds to a valve assembly such as valve assembly 260, and shows a time it takes valve assembly 260 to fully open from an initial opening. X axis 304 comprises a scale of time values and includes, as shown, three illustrated values of T1 (indicating the time when the trigger is initially actuated), T2 (indicating the time when the valve assembly corresponding to line 306 initially opens), T3 (indicating the time when valve assembly 360 corresponding to line 308 initially opens), and T4 (indicating the time when the valve assemblies are fully open).

As can be seen, the valve assembly associated with line 306 (e.g., valve assembly 160) initially opens (as indicated by T2) more quickly than valve assembly 260 initially opens (as indicated by T3). This is because the valve assembly 260 allows for an amount of movement of the trigger without opening the valve, as previously discussed. However, as can be seen, the valve assembly associated with line 306 takes longer to fully open from an initial opening, as indicated by valve open time 316 representing an amount of time between T2, when the valve assembly associated with line 306 initially opens, and T4, when the valve assembly associated with line 306 fully opens. On the other hand, valve assembly 260 (associated with line 308) fully opens more quickly from an initial opening, as indicated by valve open time 318 representing an amount of time between T3, when the valve assembly 260 initially opens, and T4, when the valve assembly 260 fully opens. It will be understood that the time between T1 and T3 represents the initial phase of movement of valve assembly 260 (e.g., the closing the gap or energy storage phase). It will be understood that the time between T3 and T4 represents the subsequent phase of movement of valve assembly 260 (e.g., the energy release phase).

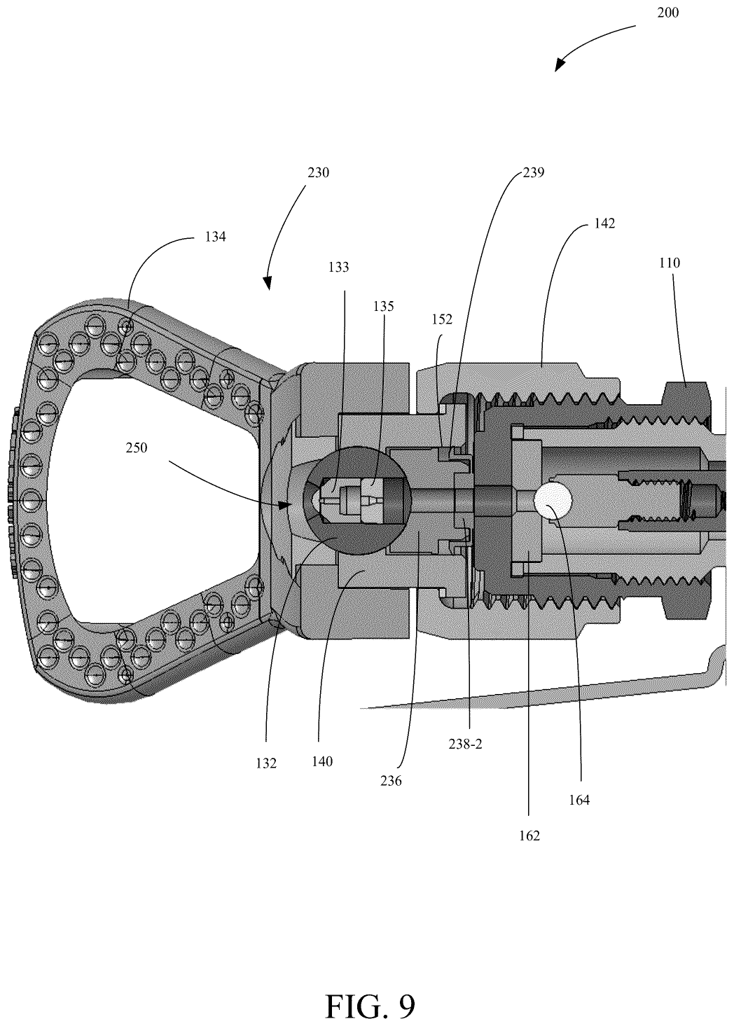

FIG. 9 is a sectional view showing another example of fluid applicator 200. Fluid applicator 200, in the example shown in FIG. 9, includes a seal 238-2, different than the seal 238-1 shown in FIG. 6. Seal 238-2 includes a captivating wing 239 that contacts the inner surface 152 of retaining element 140 to create a friction fit between seal 238-2 and retaining element 140 to retain seal 238 and tip saddle 236 within spray tip assembly 230 when tip assembly is uncoupled from gun 110 (e.g., when coupling mechanism is unthreaded from the threads of gun 110).

It will be understood that seal 238 (whether 238-1 or 238-2) can comprise a non-metallic material, such as a hard polymer (e.g., hard plastic). In one example, seal 238 comprises nylon. In other fluid applicators, the seals, such as seal 138, can comprise rubber. Seal 238 comprising a hard polymer (e.g., hard plastic), such as nylon, reduces the elasticity of the seal 238 and thus reduces the pressure accumulation of the volume downstream of the volume as compared to a seal, such as seal 138, comprising a more elastic material, such as rubber.

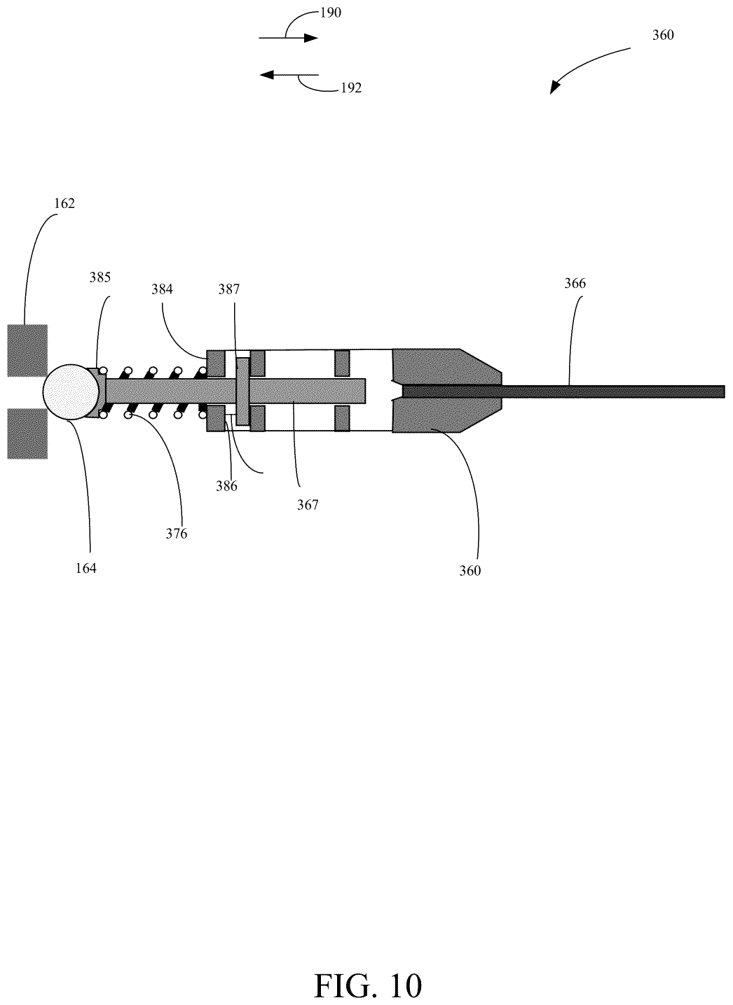

FIG. 10 is a simplified pictorial illustration showing one example of a valve assembly 360 that can be used as alternative to valve assembly 260. It will be understood that valve assembly 360, like the valve assembly 260, includes an additional spring (in addition to spring 170), though the additional spring in valve assembly 360 shown in FIG. 10 is disposed in the valve fluid volume 112. The valve assembly 360 can be used in a fluid applicator, such as fluid applicator 100 (in place of valve assembly 160) or such as fluid applicator 200 (in place of valve assembly 260). It will be understood that, though not shown in FIG. 10, valve assembly 360 further includes spring plate 168, spring 170, and seal 172, and other items, as shown in FIG. 5.

Valve assembly 360, shown in FIG. 10, includes valve seat 162, valve ball 164, valve shaft 366, valve ball shaft 367, additional spring 376, and coupling mechanism 383.

Coupling mechanism 383 couples valve shaft 366 to valve ball shaft 367 and thus, to valve ball 164. Additional spring 376 is a tension spring that is tensioned to rest in, and return to, the state shown in FIG. 10. Spring 376 is coupled between a shoulder 384 of coupling mechanism 383 and a shoulder 385 of valve ball shaft 367. During an initial phase of movement (e.g., energy storage phase), when trigger 126 (not shown in FIG. 10) is actuated in the direction 190, valve shaft 366 (by virtue of connection to spring plate 168 as previously described) and thus, coupling mechanism 383 (by virtue of connection to valve shaft 366) will move in the direction 190. This movement will also cause spring 376 to stretch in the direction 190, storing energy in spring 376, until shoulder 386 of coupling mechanism 383 abuts (or contacts) shoulder 387 of valve ball stem 383. During this initial phase of movement, the valve ball 164 is not dislodged from the valve seat 162. Thus, it will be understood that the double spring system shown in FIG. 10 allows for an amount of expansion of the tension spring 376 before the valve ball 164 is dislodged from the valve seat 162. That is, the double spring system shown in FIG. 10, allows for an amount of movement of valve shaft 366 before dislodging of the valve ball 164. The amount of movement is defined by the adjustable gap 378 between shoulder 386 and shoulder 387. During a subsequent phase of movement (e.g., energy release phase), tension spring 376 will snap back to its tensioned state (releasing the stored energy), pulling and dislodging valve ball 174 from valve seat by driving movement of valve ball shaft 366 in the direction 190, which assists in more quickly opening the valve.

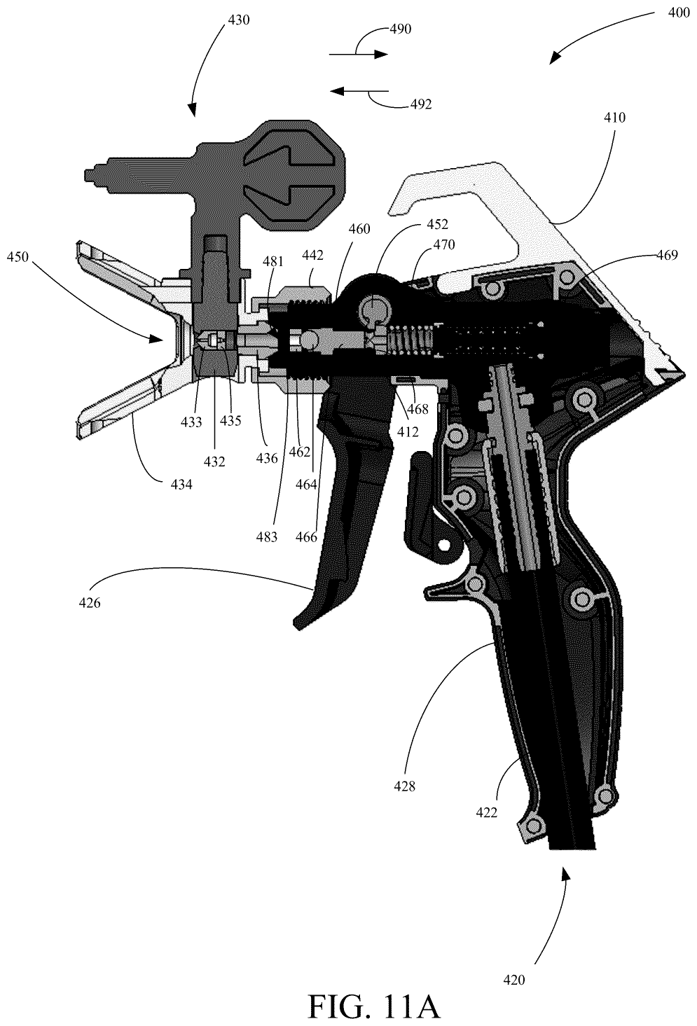

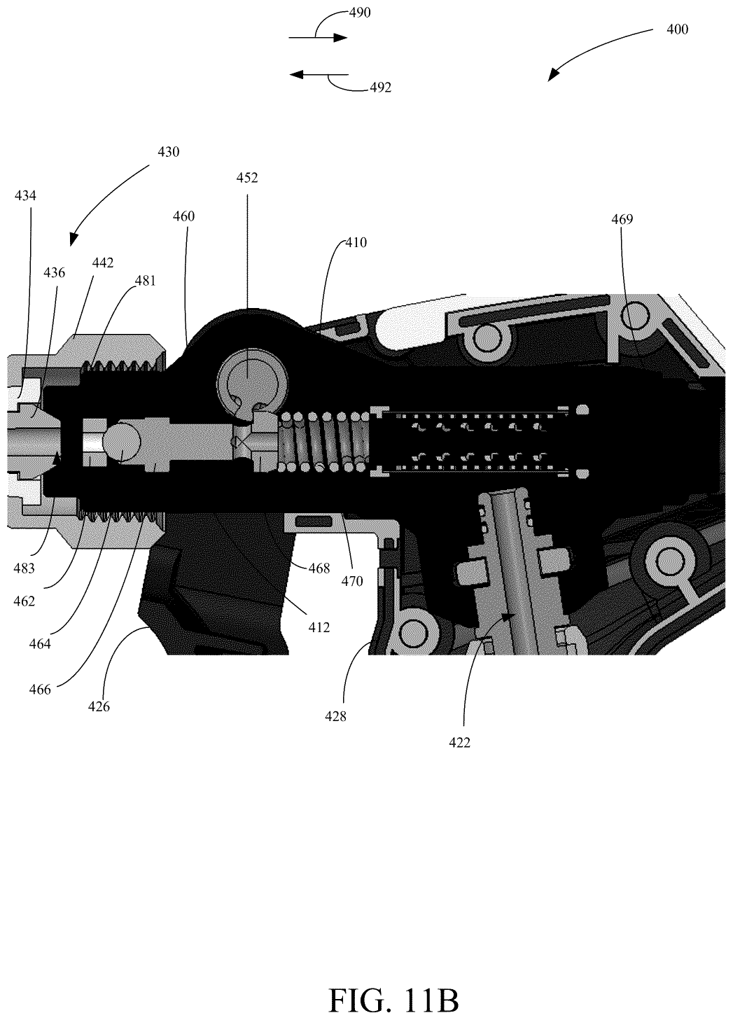

FIGS. 11A-B (collectively referred to herein as FIG. 11) are sectional views showing one example fluid applicator 400, illustratively a spray gun. Fluid applicator 400 can be used in a fluid application system, such as fluid application system 1 shown in FIG. 1, in place of fluid applicator 10.

Spray gun 400 includes gun (or gun body) 410, inlet 420, trigger 426, spray tip assembly 430, outlet 450, and valve assembly 460. Gun 410 includes, among other things, valve fluid volume 412, inlet fluid volume 422, handle 428, valve contacting member 452, and can include various other items.

Inlet 420 is coupled to a delivery line (e.g., 6) and is configured to receive fluid pumped through the delivery line. Fluid enters gun 410 through inlet 420 and travels through inlet fluid volume 422, disposed within handle 428, to valve fluid volume 412.

Spray tip assembly 430 includes spray tip 432, outlet guard 434, tip saddle 436, and coupling mechanism 442. Spray tip 432 can be similar to an used in place of spray tip 32. Spray tip 432 includes tip piece 433 and pre-orifice piece 435. In other examples, spray tip 432 could include, as a pre-orifice element, a pre-orifice formed in the body of spray tip 432 rather than a pre-orifice element as a separate pre-orifice piece, such as pre-orifice piece 435. In other examples of spray tip 432, a pre-orifice element, such as a pre-orifice piece 435, need not be included. Tip piece 433 defines outlet 450 and is configured to emit fluid in a desired spray pattern. Spray tip 432 and tip saddle 436 are disposed within retaining element 440. Spray tip 432 is rotatable within outlet guard 434 between a normal operating position (shown in FIG. 11, where outlet 450 is facing away from gun 410) and a cleaning operating position (where outlet 450 is facing toward gun 410). Outlet guard 434 is coupled to coupling mechanism 442, such as by a snap-on connection. Coupling mechanism 442 is also coupled to gun body 410 (threaded connection in the illustrated example) and thereby couples spray tip assembly 430 to gun 410.

Additionally, it can be seen that tip saddle 436 is tapered and is disposed partially within the outlet 481 of gun 410 and defines an inlet 482 of spray tip assembly 483. The exterior surface of tip saddle 436 forms as seal between gun 410 and spray tip assembly 430.

Valve assembly (or valve) 460 includes valve seat 462, valve ball 464, valve shaft 466, and spring 470, and can include various other items. Valve assembly 460 is moveable, in the directions 490 and 492, by actuation of the trigger 426 (as described below), between a seated (or closed) position (as shown in FIG. 11) and a plurality of open positions (from initially open to fully open). It will be appreciated by those skilled in the art that there is a range of open positions of valve assembly 460, the range extending between an initial point when valve ball 464 is retracted sufficiently to initially allow some fluid through valve seat 462 to spray tip assembly 430, though the valve ball 464 is still disrupting flow through the valve seat 462, and a fully open (or fully retracted) point in which valve assembly 460 is retracted to the fullest extent and the valve ball 464 is fully pulled away from valve seat 462. In other words, it will be understood that the valve assembly 460 can effectively control the flow rate of fluid to the fluid volume of spray tip assembly 430.

Trigger 426 is moveably coupled to the gun body 410, specifically to a valve contacting member 452, and is moveable, such as by application and release (or reduction) of force from a user's hand, in directions 490 and 492, between a deactivated (or resting) position (shown in FIG. 11) and an activated position. Trigger 426 is coupled to valve contacting member 452 such that actuation of trigger 426 in the direction 490 causes rotation of valve contacting member 452. As valve contacting member 452 rotates, from the actuation of trigger 426 in the direction 490, valve contacting member 452 abuts and pushes against shoulder 468 of valve shaft 466 to move valve shaft 466 in the direction 490 and thereby compresses spring 470, between valve shaft 466 and filter 469, to open valve assembly 460. When valve assembly 460 is opened, fluid flows from valve fluid volume 412, through seat 462, out of gun outlet 481 to spray tip assembly 430 through spray tip assembly inlet 483.

Spring 470 biases valve assembly 460 in a closed position, and is compressible, as described above, to open valve assembly 460. Hydrostatic pressure of fluid in valve chamber 412 also biases valve 460 in a closed position. The biasing force of the spring 470 and of the hydrostatic pressure can be overcome by application of force to trigger 426.

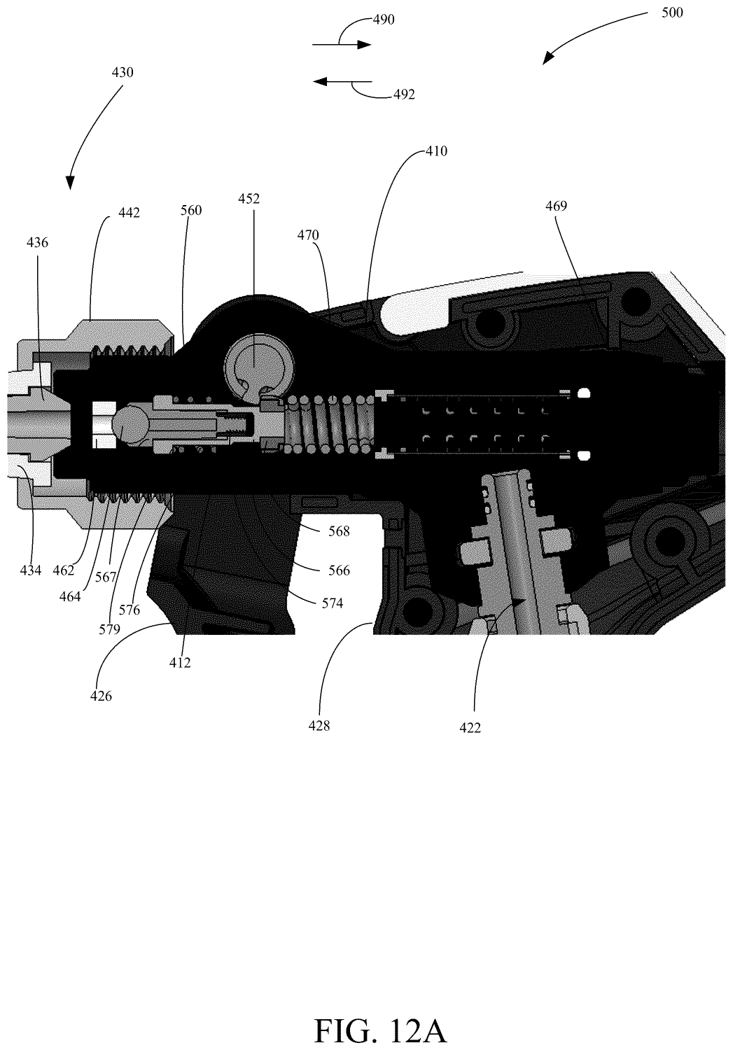

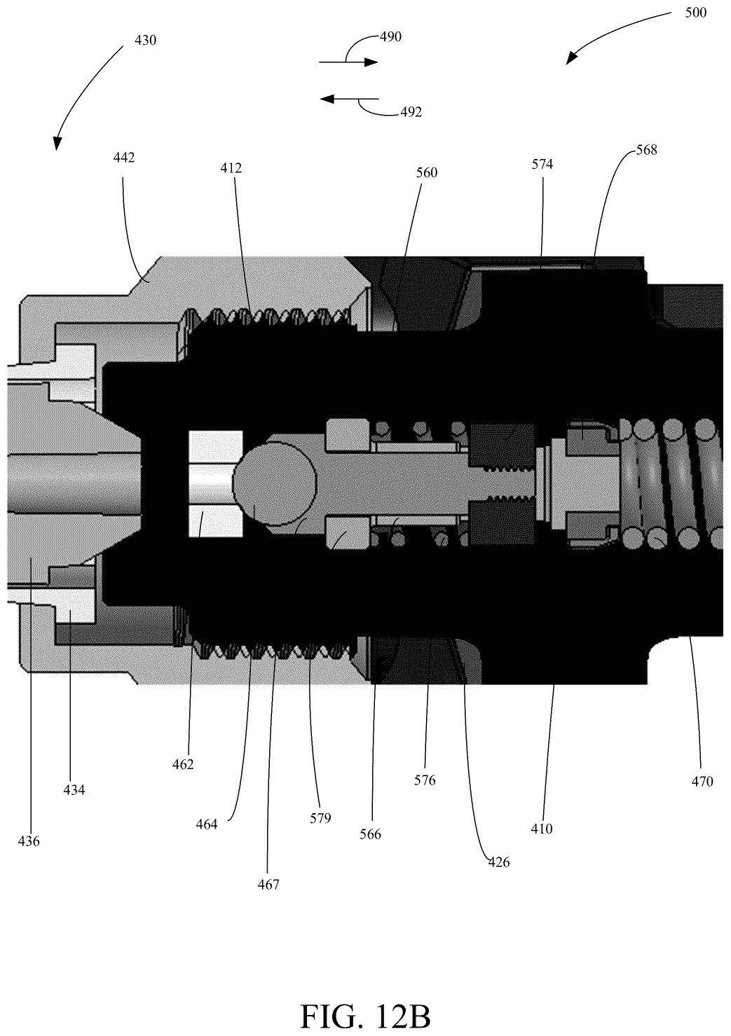

FIGS. 12A-B (collectively referred to herein as FIG. 12) are sectional views showing one example fluid applicator 500, illustratively a spray gun. FIG. 12A is a side sectional view and FIG. 12B is a top sectional view. Fluid applicator 500 can be used in a fluid application system, such as fluid application system 1 shown in FIG. 1, in place of fluid applicator 10. Fluid applicator 500 is similar to fluid applicator 400 shown in FIG. 11 and thus, similar items are numbered similarly.

It can be seen in FIG. 12 that fluid applicator 500 includes a valve assembly 560. Valve assembly 560 differs from valve assembly 460 in that valve assembly 560 includes valve shaft 566, different than valve shaft 466, valve ball shaft 567, stop 574, and an additional spring 576.

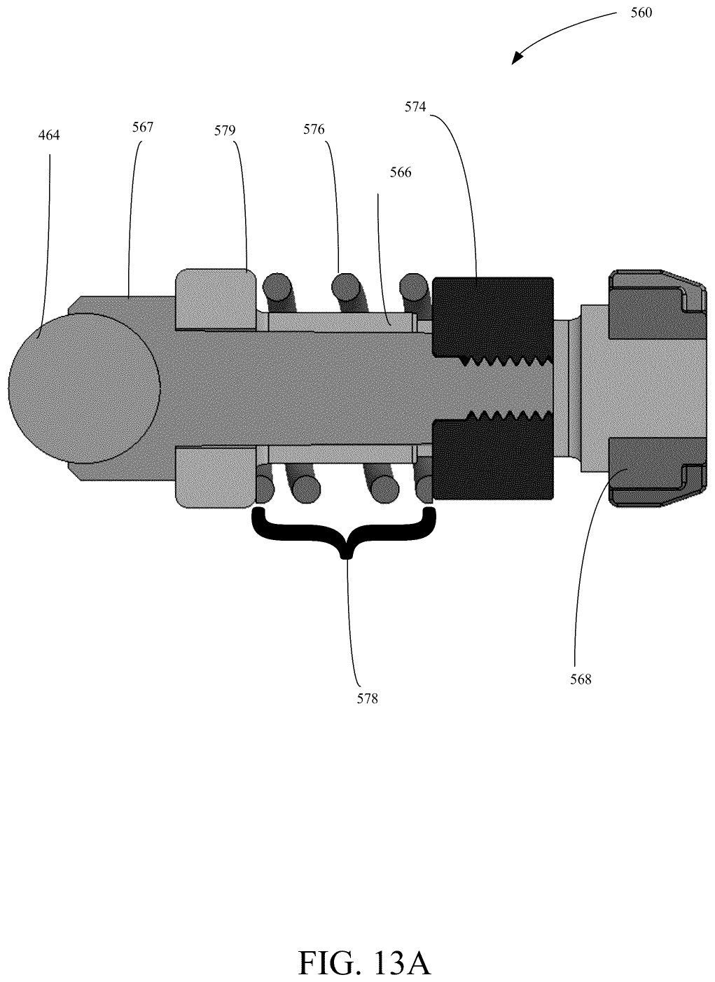

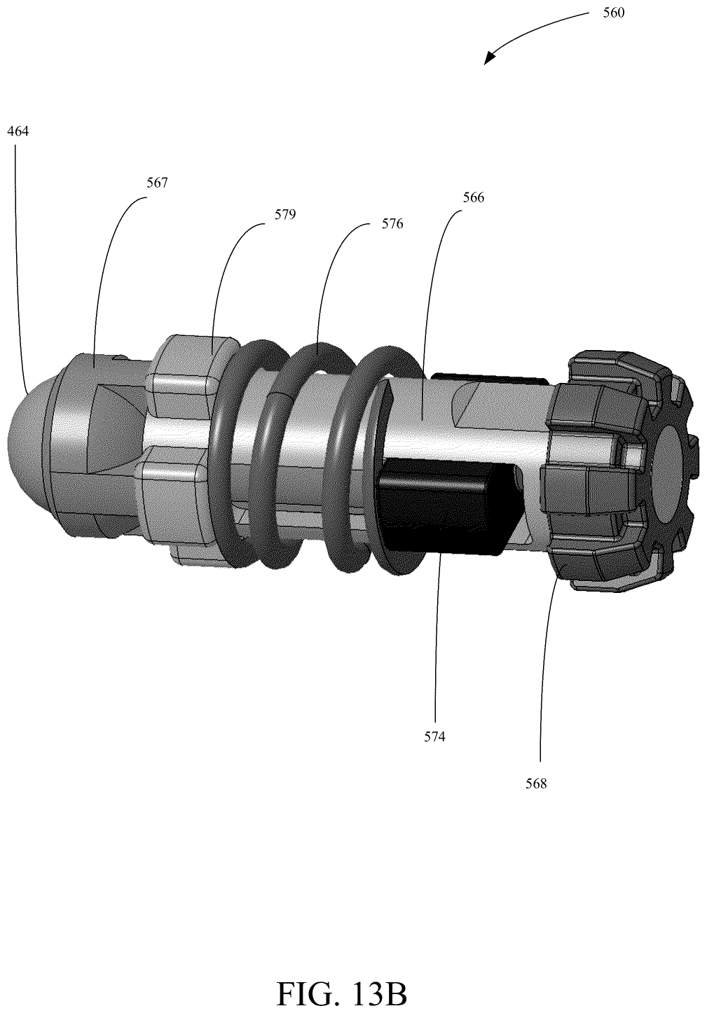

As illustrated in FIG. 12, additional spring 576 is disposed around valve shaft 566 (and valve ball shaft 567) and disposed between a shoulder 579 of valve shaft 566 and stop 574. Stop 574 also serves to secure valve shaft 566 to valve ball shaft 567, and thus valve ball 464 to valve shaft 566. It can be seen that stop 574 is coupled to valve ball stem 567 (via a threaded connection in the illustrated example). As trigger 426 is actuated in the direction 490, valve contacting member 452 rotates, as previously described. As valve contacting member 452 rotates, from the actuation of trigger 426 in the direction 490, valve contacting member 452 abuts and pushes against shoulder 568 of valve shaft 566 to move valve shaft 566 in the direction 490. During an initial phase of movement (e.g., energy storage phase) valve shaft 566, moving in the direction 490, slides along valve ball stem 467, partially compresses spring 470 between valve shaft 466 and filter 469, and compresses spring 476 between stop 574 and shoulder 579, storing energy in spring 476. During this initial phase of movement, the valve ball 464 is not dislodged from the valve seat 462. Thus, it will be understood that the double spring system shown in FIG. 12 allows for an amount of compression before the valve ball 464 is dislodged from the valve seat 462. The amount of compression is defined by the adjustable gap (578 shown in FIG. 13) between shoulder 579 and stop 574. During a subsequent phase of movement (e.g., energy release phase), as the trigger 426 continues to move in the direction 490, the additional spring 576 will release the stored energy and drive movement of valve ball shaft 567 (and thus valve ball 464) in the direction 490 (dislodging valve ball 464 from valve seat 462) and will assist in opening the valve more quickly.

FIG. 13A is a sectional top view of valve assembly 560. FIG. 13B is a perspective view of valve assembly 560.

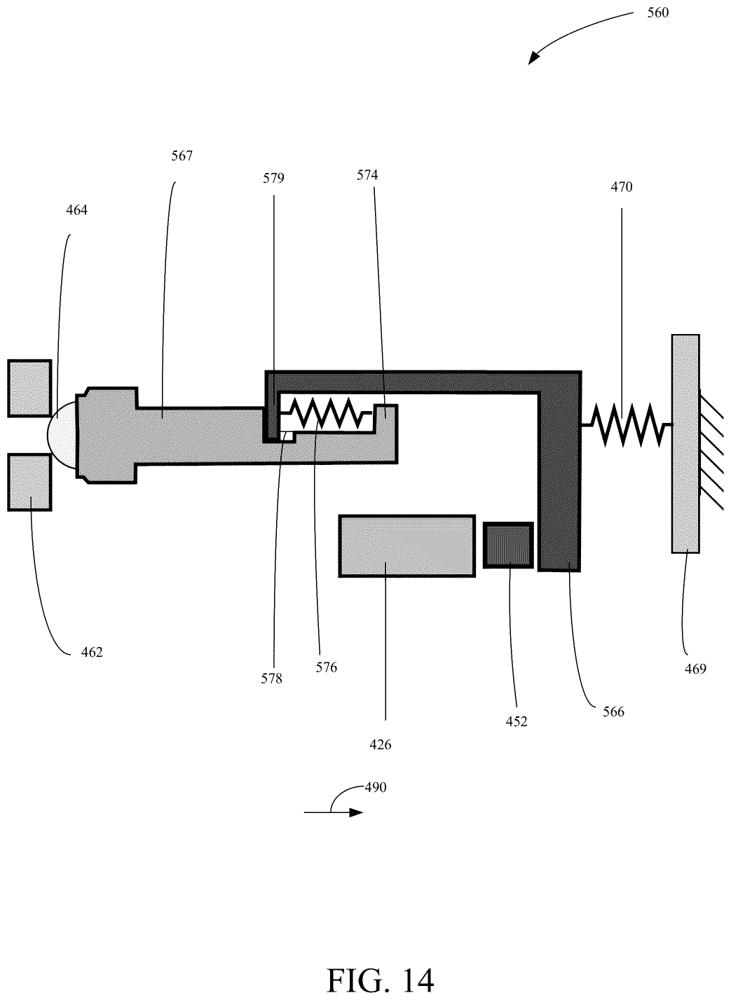

FIG. 14 is a schematic illustration of one example of valve assembly 560. As shown in FIG. 14, actuation of trigger 426 in direction 490 causes valve contacting member 452 to push against and drive valve shaft 566 in the direction 490. During the initial phase of movement, valve shaft 566 compresses spring 470 and spring 576, storing energy in spring 576. In a subsequent phase of movement, spring 576 releases the stored energy, and drives movement of valve ball stem 567 (and thus valve ball 464) in the direction 490 (dislodging valve ball 464 from valve seat 462) and will assist in opening the valve more quickly.

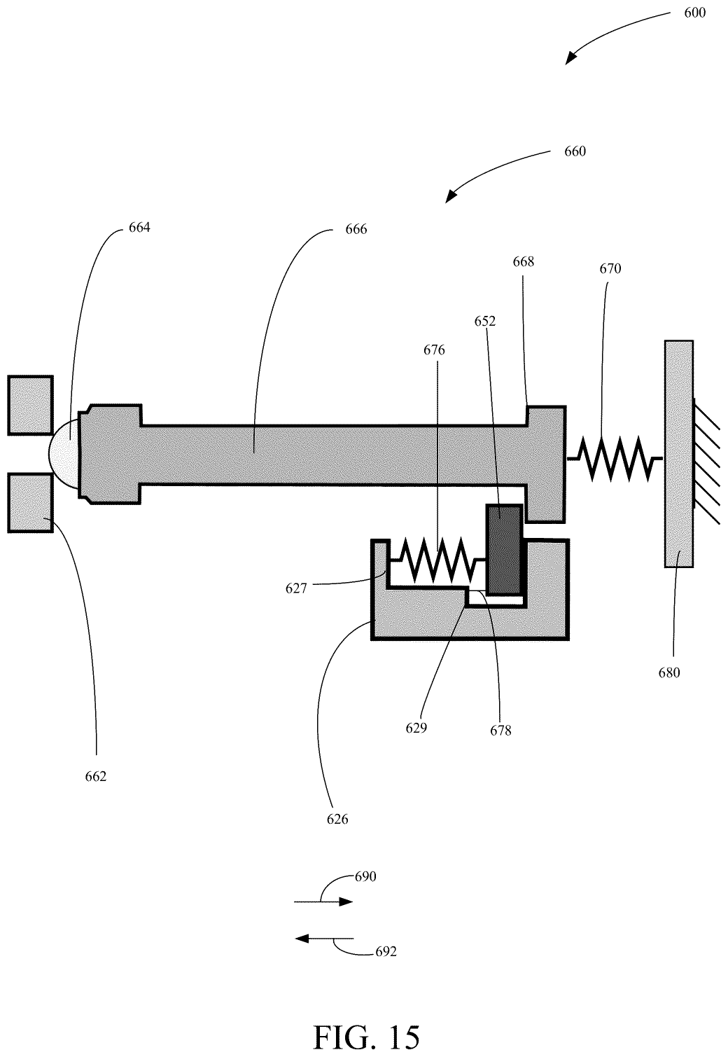

FIG. 15 is a schematic illustration of one example fluid applicator 600 illustrating example operation of a valve assembly 660. Fluid applicator 600 can be used in a fluid application system, such as fluid application system 1 shown in FIG. 1, in place of fluid applicator 10.

As illustrated fluid applicator 600 includes trigger 626 and valve contacting member 652. Valve assembly 660 includes valve seat 662, valve ball 664, valve shaft 666, spring 670, and additional spring 676. Trigger 626 is moveably coupled to a gun body (not shown in FIG. 15) and is moveable, such as by application and release (or reduction) of force from user's hand, in directions 690 and 692, between a deactivated (or resting) position (shown in FIG. 15) and an activated position. As can be seen, in an initial phase of movement (e.g., energy storage phase), as trigger is actuated in direction 690, spring 676 is compressed between shoulder 627 of trigger 626 and valve contacting member 652, storing energy in spring 676, until an adjustable gap 678 between trigger 626 (e.g., shoulder 629 of trigger 626) and valve contacting member 652 is closed. During this initial phase of movement, the valve ball 664 is not dislodged from the valve seat 662. Thus, it will be understood that the double spring system shown in FIG. 15 allows for an amount of compression before the valve ball 664 is dislodged from the valve seat 662. The amount of compression is defined by the adjustable gap 678. During a subsequent phase of movement (e.g., energy release phase), as the trigger 626 continues to move in the direction 690, trigger 626 pushes against valve contacting member 652 which in turn pushes against shoulder 668 of valve shaft 666 and thus, drives valve shaft 666 and valve ball 664 in the direction 690 and compresses spring 670 against element 680, opening the valve. During the subsequent phase of movement, the spring 676 releases the stored energy and assists in driving movement of the valve shaft 666 (and thus the valve ball 664) in the direction 690 by assisting in driving valve contacting member 652 against the valve shaft 666. Thus, the spring 676, in the subsequent phase of movement, will assist in opening the valve more quickly.

It will be understood that element 680 could be a filter, similar to filter 469, or a cap, similar to cap 173, or could be another element, such as a gun body.

Though not shown in FIG. 15, it will be understood that fluid applicator 600 can further include various other elements, such as elements of other fluid applicators shown herein, for example, but not by limitation, a spray tip (e.g. 32, 132, 432, etc.) or spray tip assembly (e.g., 130, 230, 430, etc.).

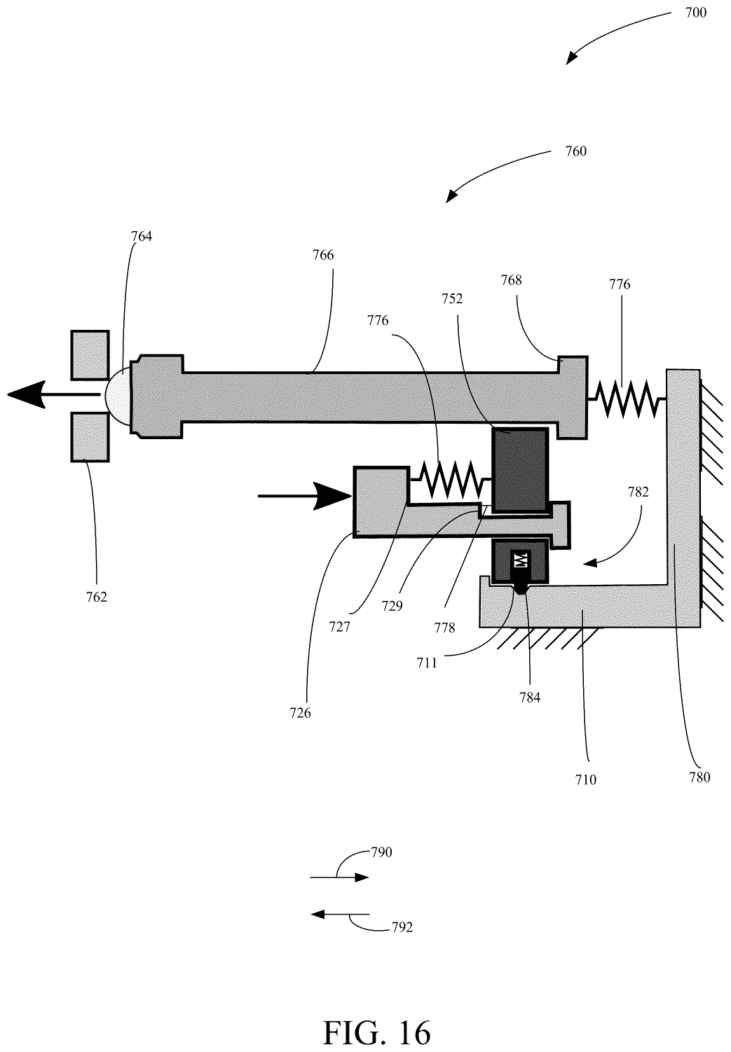

It will be understood that, in the examples of multi-spring valve assemblies 260, 360, 560, and 660, as the valve initially opens, pressure across the valve equalizes. The hydrostatic pressure, biasing the valve to a closed position, will be released, the release of which helps to allow the stored energy of the additional spring (e.g., 276, 376, 576, or 676) to open the valve more quickly. The resulting effect of the operation of the multi-spring valve assemblies 260, 360, 560, and 660 is a “snap open” of the valve. In the example of valve assemblies shown in FIGS. 16-19, the release of a mechanical stop (e.g., detent mechanism, latch, etc.), rather than just a hydrostatic pressure, helps to allow the stored energy of the second spring to open the valve more quickly. In all of the example multi-spring valve assemblies shown herein, a biasing force (e.g., hydrostatic pressure, mechanical stop, etc.) is released that helps to allow the stored energy of one of the springs to be released to open the valve more quickly.

FIGS. 16-19 show example fluid applicators including a mechanical stop (e.g., detent mechanism, latch, etc.), that is releasable to help allow the stored energy of the second spring to open the valve more quickly. Advantageously, the use of a mechanical stop, such as shown in FIGS. 16-19, allows for use of a stronger spring, as the second spring, than the second spring of previous examples as the mechanical stop can provide more resistance than hydrostatic pressure and thus allow for compression of a stronger spring. A stronger second spring will result in an even faster opening of the valve.

FIG. 16 is a schematic illustration of one example fluid applicator 700 illustrating example operation of a valve assembly 760. Fluid applicator 700 can be used in a fluid application system, such as fluid application system 1 shown in FIG. 1, in place of fluid applicator 10.

As illustrated, fluid applicator 700 includes trigger 726 and valve contacting member 752. Valve assembly 760 includes valve seat 762, valve ball 764, valve shaft 766, spring 770, and an additional spring 776. Valve contacting member 752 includes a mechanical stop 782 (illustratively a spring-loaded detent mechanism) that includes a spring-loaded pin 784. Trigger 726 is moveably coupled to a gun body 710 (only shown in part in FIG. 16) and is moveable, such as by application and release (or reduction) of force from a user's hand, in directions 790 and 792, between a deactivated (or resting) position (as shown in FIG. 16) and an activated position. As can be seen, in an initial phase of movement (e.g., energy storage phase), as trigger 726 is actuated in the direction 790, spring 776 is compressed between shoulder 727 of trigger 726 and valve contacting member 752, storing energy in spring 776, until an adjustable gap 778 between trigger (e.g., shoulder 729 of trigger 726) and valve contacting member 752 is closed. During this initial phase of movement, the valve ball 764 is not dislodged from the valve seat 762. Thus, it will be understood that the double spring system shown in FIG. 16 allows for an amount of compression before the valve ball 764 is dislodged from the valve seat 762. The amount of compression is defined by the adjustable gap 778. The mechanical stop 782 (by virtue of pin 784 being disposed in recess 711 of gun body 710) provides resistance to the force of spring 776 such that valve shaft 766 is not moved. During a subsequent phase of movement (e.g., energy release phase), once the gap 778 is closed, with trigger 726 continuing to move in direction 790. the additional force applied by trigger 726 of valve contacting member 752 will cause pin 784 to retract out of recess 711 and allow for movement of valve contacting member 752 and release of the stored energy of spring 776. Thus, during the subsequent phase of movement, the spring 776 releases the stored energy and assists in driving movement of the valve shaft 766 (and thus the valve ball 764) in the direction 790 by assisting in driving valve contacting member 752 against the valve shaft 766. Thus, the spring 776, in the subsequent phase of movement, will assist in opening the valve more quickly. During the subsequent phase of movement, spring 770 is also compressed against element 780.

It will be understood that element 780 could be a filter, similar to filter 469, or a cap, similar to cap 173, or could be a part of gun body 710.

Though not shown in FIG. 16, it will be understood that fluid applicator 700 can further include various other elements, such as elements of other fluid applicators shown herein, for example, but not by limitation, a spray tip (e.g. 32, 132, 432, etc.) or spray tip assembly (e.g., 130, 230, 430, etc.).

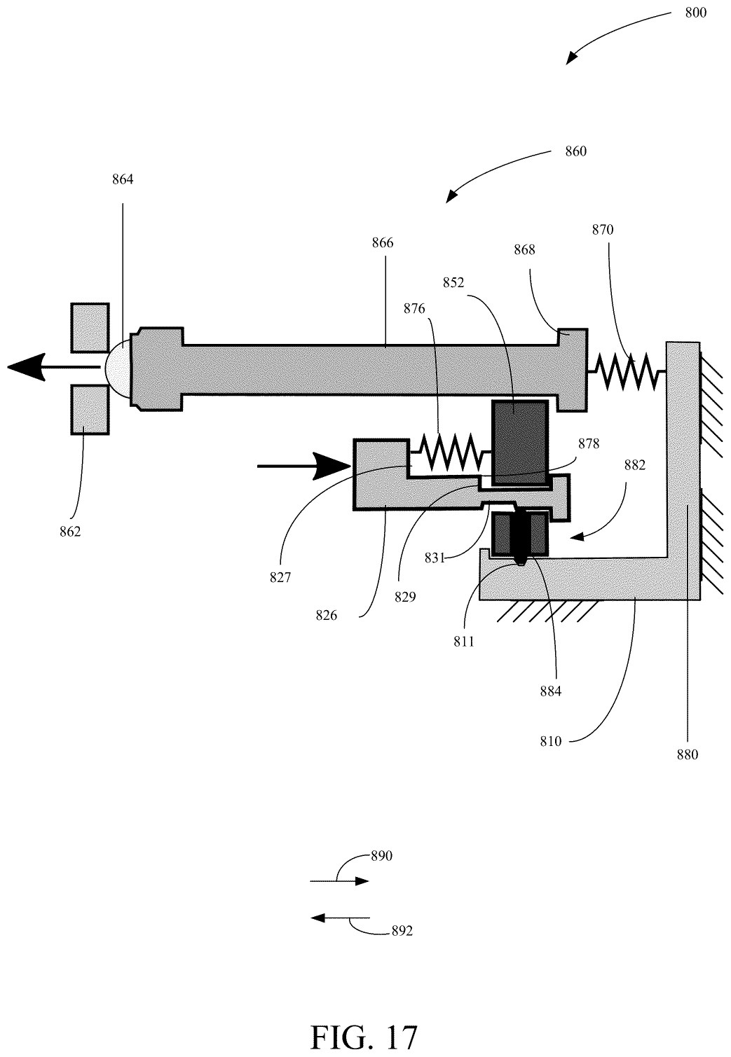

FIG. 17 is a schematic illustration of one example fluid applicator 800 illustrating example operation of a valve assembly 860. Fluid applicator 800 can be used in a fluid application system, such as fluid application system 1 shown in FIG. 1, in place of fluid applicator 10.

As illustrated, fluid applicator 800 includes trigger 826 and valve contacting member 852. Valve assembly 860 includes valve seat 862, valve ball 864, valve shaft 866, spring 870, and an additional spring 876. Valve contacting member 852 includes a mechanical stop 882 (illustratively a detent mechanism) that includes a pin 884. Trigger 826 is moveably coupled to a gun body 810 (only shown in part in FIG. 17) and is moveable, such as by application and release (or reduction) of force from a user's hand, in directions 890 and 892, between a deactivated (or resting) position (as shown in FIG. 17) and an activated position. As can be seen, in an initial phase of movement (e.g., energy storage phase), as trigger 826 is actuated in the direction 890, spring 876 is compressed between shoulder 827 of trigger 826 and valve contacting member 852, storing energy in spring 876, until an adjustable gap 878 between trigger (e.g., shoulder 829 of trigger 826) and valve contacting member 852 is closed. During this initial phase of movement, the valve ball 864 is not dislodged from the valve seat 862. Thus, it will be understood that the double spring system shown in FIG. 17 allows for an amount of compression before the valve ball 864 is dislodged from the valve seat 862. The amount of compression is defined by the adjustable gap 878. The mechanical stop 882 (by virtue of pin 884 being disposed in recess 811 of gun body 810) provides resistance to the force of spring 876 such that valve shaft 866 is not moved. During a subsequent phase of movement (e.g., energy release phase), once the gap 878 is closed, with trigger 826 continuing to move in direction 890, pin 884 will retract out of recess 811 and extend into recess 837 of trigger 826, which will allow for movement of valve contacting member 852 and release of the stored energy of spring 876. Thus, during the subsequent phase of movement, the spring 876 releases the stored energy and assists in driving movement of the valve shaft 866 (and thus the valve ball 864) in the direction 890 by assisting in driving valve contacting member 852 against the valve shaft 866 (e.g., against shoulder 868 of valve shaft 866). Thus, the spring 876, in the subsequent phase of movement, will assist in opening the valve more quickly. During the subsequent phase of movement, spring 870 is also compressed against element 880.

It will be understood that element 880 could be a filter, similar to filter 469, or a cap, similar to cap 173, or could be a part of gun body 810.

Though not shown in FIG. 17, it will be understood that fluid applicator 800 can further include various other elements, such as elements of other fluid applicators shown herein, for example, but not by limitation, a spray tip (e.g. 32, 132, 432, etc.) or spray tip assembly (e.g., 130, 230, 430, etc.).

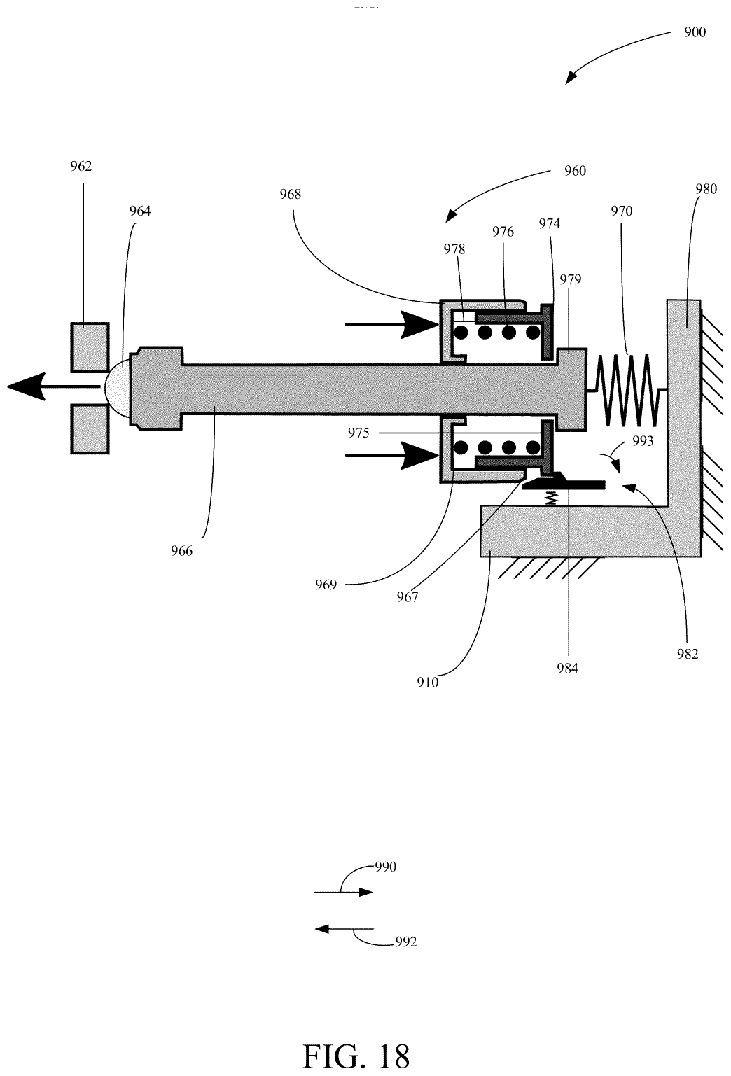

FIG. 18 is a schematic illustration of one example fluid applicator 900 illustrating example operation of a valve assembly 960. Fluid applicator 900 can be used in a fluid application system, such as fluid application system 1 shown in FIG. 1, in place of fluid applicator 10.

As illustrated, fluid applicator 900 includes valve assembly 960. Valve assembly 960 includes valve seat 962, valve ball 964, valve shaft 966, spring 970, additional spring 976, spring plate 968, spring clip 974, mechanical stop 982 (illustratively a spring-loaded latch) that includes a latch plate 984. Fluid applicator 900 can also include a trigger (not shown in FIG. 18) moveably coupled to a gun body 910 (only shown in part in FIG. 18) and moveable, such as by application and release (or reduction) of force from a user's hand, in directions 990 and 992, between a deactivated (or resting) position (as shown in FIG. 18) and an activated position. Further, the trigger is coupled to the spring plate 968 such that movement of trigger causes movement of spring plate 968. As can be seen, in an initial phase of movement (e.g., energy storage phase), as the spring plate 968 is actuated in the direction 990 (by actuation of the trigger), spring 976 is compressed between shoulder 969 of spring plate 968 and spring clip 974 (shoulder 975 of spring clip 975), storing energy in spring 976, until an adjustable gap 978 between spring plate 968 (e.g., shoulder 969 of spring plate 968) and spring clip 974 (e.g., an end of spring clip 974) is closed. During this initial phase of movement, the valve ball 964 is not dislodged from the valve seat 962. Thus, it will be understood that the double spring system shown in FIG. 18 allows for an amount of compression before the valve ball 964 is dislodged from the valve seat 962. The amount of compression is defined by the adjustable gap 978. The mechanical stop 982 (by virtue of the spring-loaded resistance of latch plate 984 and the contact thereof with spring clip 974) provides resistance to the force of spring 976 such that valve shaft 966 is not moved. During a subsequent phase of movement (e.g., energy release phase), once the gap 978 is closed, with the trigger continuing to move in direction 990, an end 967 of spring plate 968 will contact latch plate 984 and cause latch plate 984 to move in the direction indicated by arrow 993, which will allow for movement of spring clip 974 and release of the stored energy of spring 976. Thus, during the subsequent phase of movement, the spring 976 releases the stored energy and assists in driving movement of the valve shaft 966 (and thus the valve ball 964) in the direction 990 by assisting in driving spring clip 974 against the valve shaft 966 (e.g., against the shoulder 979 of valve shaft 966). Thus, the spring 976, in the subsequent phase of movement, will assist in opening the valve more quickly. During the subsequent phase of movement, spring 970 is also compressed against element 980.

It will be understood that when the trigger is released and the valve assembly is correspondingly moved in the direction 992, the mechanical stop will return to the position shown in FIG. 18.

It will be understood that element 980 could be a filter, similar to filter 469, or a cap, similar to cap 173, or could be a part of gun body 910.

Though not shown in FIG. 18, it will be understood that fluid applicator 900 can further include various other elements, such as elements of other fluid applicators shown herein, for example, but not by limitation, a spray tip (e.g. 32, 132, 432, etc.) or spray tip assembly (e.g., 130, 230, 430, etc.).

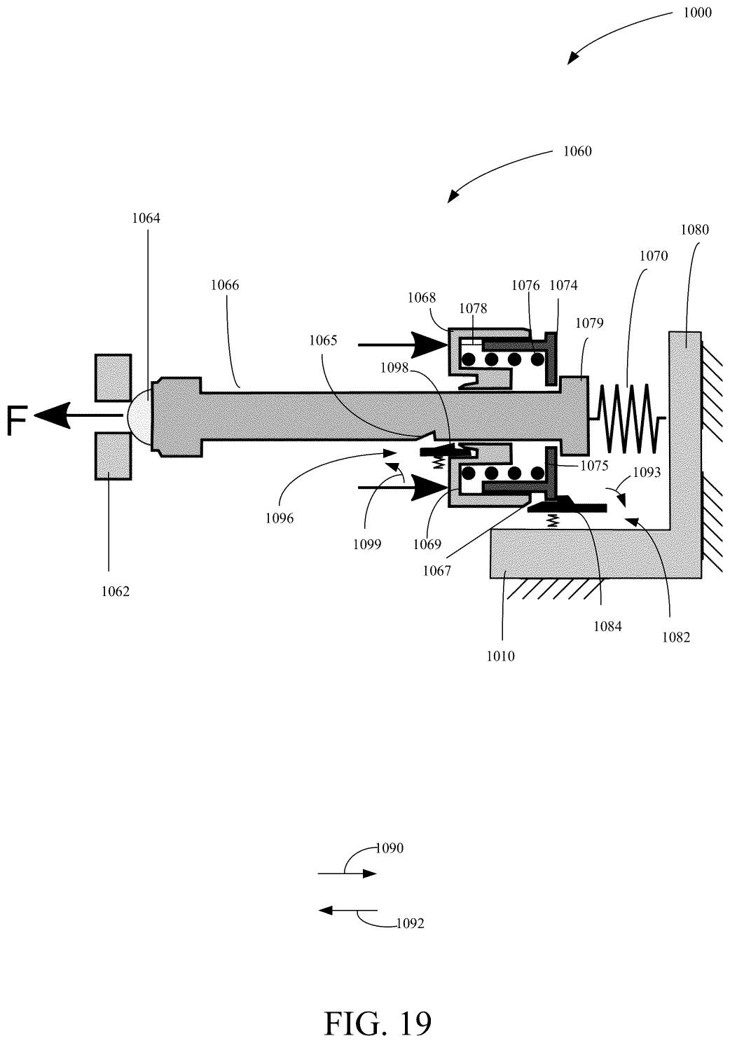

FIG. 19 is a schematic illustration of one example fluid applicator 1000 illustrating example operation of a valve assembly 1060. Fluid applicator 1000 can be used in a fluid application system, such as fluid application system 1 shown in FIG. 1, in place of fluid applicator 10.

As illustrated, fluid applicator 1000 includes valve assembly 1060. Valve assembly 1060 includes valve seat 1062, valve ball 1064, valve shaft 1066, spring 1070, additional spring 1076, spring plate 1068, spring clip 1074, mechanical stop 1082 (illustratively a spring-loaded latch) that includes a latch plate 1084, mechanical stop 1096 (illustratively a spring-loaded latch) that includes a latch plate 1098. Fluid applicator 1000 can also include a trigger (not shown in FIG. 19) moveably coupled to a gun body 1010 (only shown in part in FIG. 19) and moveable, such as by application and release (or reduction) of force from a user's hand, in directions 1090 and 1092, between a deactivated (or resting) position (as shown in FIG. 19) and an activated position. Further, the trigger is coupled to the spring plate 1068 such that movement of trigger causes movement of spring plate 1068. As can be seen, in an initial phase of movement (e.g., energy storage phase), as the spring plate 1068 is actuated in the direction 1090 (by actuation of the trigger), spring 1076 is compressed between shoulder 1069 of spring plate 1068 and spring clip 1074 (shoulder 975 of spring clip 975), storing energy in spring 1076, until an adjustable gap 1078 between spring plate 1068 (e.g., shoulder 1069 of spring plate 1068) and spring clip 1074 (e.g., an end of spring clip 1074) is closed. During this initial phase of movement, the valve ball 1064 is not dislodged from the valve seat 1062. Thus, it will be understood that the double spring system shown in FIG. 19 allows for an amount of compression before the valve ball 1064 is dislodged from the valve seat 1062. The amount of compression is defined by the adjustable gap 1078. The mechanical stop 1082 (by virtue of the spring-loaded resistance of latch plate 1084 and the contact thereof with spring clip 1074) provides resistance to the force of spring 1076 such that valve shaft 1066 is not moved. During a subsequent phase of movement (e.g., energy release phase), once the gap 1078 is closed, with the trigger continuing to move in direction 1090, an end 1067 of spring plate 1068 will contact latch plate 1084 and cause latch plate 1084 to move in the direction indicated by arrow 1093, which will allow for movement of spring clip 1074 and release of the stored energy of spring 1076. Thus, during the subsequent phase of movement, the spring 1076 releases the stored energy and assists in driving movement of the valve shaft 1066 (and thus the valve ball 1064) in the direction 1090 by assisting in driving spring clip 1074 against the valve shaft 966 (e.g., against the shoulder 1079 of valve shaft 1066). Thus, the spring 1076, in the subsequent phase of movement, will assist in opening the valve more quickly. During the subsequent phase of movement, spring 1070 is also compressed against element 980.

Additionally, during the subsequent phase of movement, by virtue of movement of spring plate 1068 in the direction 1090, latch plate 1098 will move in the direction 1099 and extend into recess 1065 of valve shaft 1066. When trigger is released, an amount of movement of spring plate 1068 in the direction 1092 is allowed before valve shaft 1066 is moved in the direction 1092 as mechanical stop 1096 will resist the force of spring 1070 and thus, resist movement of valve shaft 1066 in the direction 1092. Eventually, with continual movement of spring plate 1068 in the direction 1092, spring plate 1068 will contact latch plate 1098 and latch plate 1098 will move in the direction 1093 and retract out of recess 1065, allowing the stored energy of spring 1070 to release and close the valve more quickly, which will help to reduce spitting.

It will be understood that when the trigger is released and the valve assembly is correspondingly moved in the direction 1092, the mechanical stop will return to the position shown in FIG. 19.

It will be understood that element 1080 could be a filter, similar to filter 469, or a cap, similar to cap 173, or could be a part of gun body 1010.

Though not shown in FIG. 19, it will be understood that fluid applicator 1000 can further include various other elements, such as elements of other fluid applicators shown herein, for example, but not by limitation, a spray tip (e.g. 32, 132, 432, etc.) or spray tip assembly (e.g., 130, 230, 430, etc.).

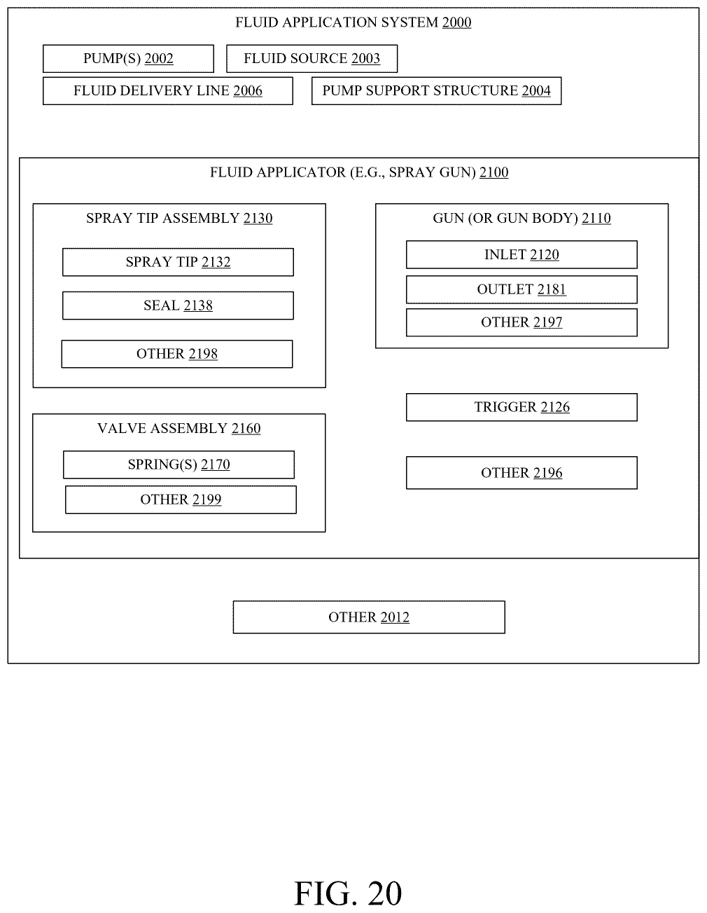

FIG. 20 is a block diagram showing one example fluid application system 2000. Fluid application system 2000 can include one or more pumps 2002, a fluid source 2003, a pump support structure 2004, a fluid delivery line 2006, a fluid applicator 2100, and can include various other items 2012, including, but not limited to, other items discussed or shown herein. Fluid applicator 2010, itself, includes gun (or gun body) 2110, trigger 2126, spray tip assembly 2130, valve assembly 2160, and can include other items 2196.

Gun (or gun body) 2110, itself, can include an inlet 2120, an outlet 2181, and can include various other items 2197. Inlet 2120 can be similar to any of the gun inlets described herein, such as inlet 120 or inlet 420, or another type of gun inlet. Outlet 2181 can be similar to any of the gun outlets described herein, such as outlet 181 or outlet 481, or another type of gun outlet. Other items 1097 can include any of the other items of guns (or gun bodies) described herein (e.g., 110, 410, 610, 710, 810, 910, 1010, etc.) as well as other items.

Spray tip assembly 2130, itself, can include spray tip 2132, seal 2138 and can include various other items 2198. Spray tip 2132 can be similar to any of the spray tips described herein, such as spray tip 32, 132, 432, or another type of spray tip. As previously discussed, a spray tip defines an outlet of the applicator and can include a tip piece and a pre-orifice element. Further, as previously discussed, a spray tip can be reversible (e.g., rotatable about its longitudinal axis such that the outlet can face away from or towards the gun body). Seal 2138 can be similar to any of the seals described herein, such as seal 138, seal 238, the seal created by tip saddle 436, or another type of seal. Various other items 2198 can include any of the other items of spray tip assemblies described herein (e.g., 130, 230, 430, etc.) as well as other items.

Valve assembly 2160, itself, can include one or more springs 2170, and can include various other items 2199. Springs 2170 can be similar to any of the springs described herein, such as spring 170, or spring 170 and spring 276, or spring 170 and spring 376, or spring 470, or spring 470 and spring 576, or spring 670 and spring 676, or spring 770 and spring 776, or spring 870 and spring 876, or spring 970 and spring 976, or spring 1070 and spring 1076, or other one or more springs. Various other items 2199 can include any of the other items of valve assemblies described herein (e.g., 160, 260, 360, 460, 560, 660, 760, 860, 960, 1060, etc.), as well as other items.

Trigger 2126 is moveably coupled to gun (or gun body) 2110 and is actuatable to open and close the valve assembly 2160. Trigger can be similar to any of the triggers described herein (e.g., 126, 426, 626, 726, 826, the trigger described in FIG. 18, the trigger described in FIG. 19, etc.).

Fluid applicator 2100 can include various other items 2196 including, but not limited to, any of the items of fluid applicators described herein (e.g., 10, 100, 200, 400, 500, 600, 700, 800, 900, 1000, etc.). Pumps 2002, in one example, can be similar to pump 2, or can be other type of pumps. A fluid source 2003 can be a fluid container, such as a paint bucket (e.g., 5-gallon paint bucket, etc.) or another type of fluid container. Pump support structure 2004 can be similar to cart 4 or can be other types of pump support structures. Fluid delivery line 2006 can be similar to fluid delivery line 6 or can be another type of fluid delivery line. Pumps 2002 pressurize and pump fluid from fluid source 2003 and deliver the pressurized fluid to fluid applicator 2100 via fluid delivery line 2006. The pumps 2002 can be supported by a pump support structure 2004, such as a cart (e.g., 4) or other pump support structure. Fluid application system 2000 can include various other items 2012.

Thus, it can be seen that the examples herein provide for reducing spitting in fluid applicators by one or more of reducing size of the fluid volume downstream of the valve, reducing pressure accumulation of a volume downstream of the valve, or increasing the speed at which the valve can actuate (e.g., increasing the speed at which the valve can open or the speed at which the valve can close, or both). Each of reducing size of the fluid volume downstream of the valve, reducing pressure accumulation of a volume downstream of the valve, or increasing the speed at which the valve can actuate can reduce spitting.

Although the present invention has been described with reference to preferred examples, workers skilled in the art will recognize that changes may be made in form and detail without departing from the spirit and scope of the invention.

Additionally, while a particular order of steps has been described for the sake of illustration, it is to be understood that some or all of these steps can be performed in any number of orders.

It should also be noted that the different examples described herein can be combined in different ways. That is, parts of one or more examples can be combined with parts of one or more other examples. All of this is contemplated herein.

What is claimed is:

1. A fluid application system comprising:
one or more pumps;
a fluid delivery line coupled to the one or more pumps; and
a fluid applicator comprising:
a gun; and
a spray tip assembly removably coupled to the gun, the spray tip assembly comprising:
a spray tip;
a tip saddle; and
a seal element disposed, at least partially, within the tip saddle and having a top surface in contact with an exterior surface of the tip saddle, the seal defining an inlet to the spray tip assembly and forming a seal between the gun and the spray tip assembly.

2. The fluid application system of claim 1, wherein the spray tip assembly further comprises:
a retaining element, the tip saddle and the spray tip disposed, at least partially, within the retaining element; and
wherein the seal element further comprises a captivating wing configured to contact an inner surface of the retaining element and thereby establish a friction fit between the seal element and the retaining element.

3. The fluid application system of claim 1, wherein the seal element comprises a hard polymer.

4. The fluid application system of claim 3, wherein the seal element comprises nylon.

5. A fluid application system comprising:
one or more pumps;
a fluid delivery line coupled to the one or more pumps; and
a fluid applicator comprising:
a spray tip assembly; and
a gun, removably coupled to the spray tip assembly, the gun comprising:
a trigger; and
a valve assembly configured to be moved in a first direction by actuation of the trigger, the valve assembly comprising:
a first spring configured to bias the valve assembly in a second direction and to be compressed by movement of the valve assembly in the first direction; and
a second spring configured to store energy in a first phase of the movement of the valve assembly in the first direction of movement and to release the stored energy in a second phase of the movement of the valve assembly in the first direction to assist in moving the valve assembly in the first direction.

6. The fluid application system of claim 5, wherein the second spring is a compression spring.

7. The fluid application system of claim 5, wherein the second spring is a tension spring.

8. The fluid application system of claim 5, wherein the gun further comprises:
a spring chamber;
a valve fluid volume; and
a seal element configured to fluidically seal the spring chamber from the valve fluid volume.

9. The fluid application system of claim 8, wherein both the first spring and the second spring are disposed in in the spring chamber.

10. The fluid application system of claim 8, wherein the first spring is disposed in the spring chamber and wherein the second spring is disposed in the valve fluid volume.

11. The fluid application system of claim 5, wherein both the first spring and second spring are configured to contact fluid applied by the fluid application system.

12. The fluid application system of claim 5, wherein the second spring is in contact with the trigger.

13. A fluid applicator comprising:
a gun comprising:
a trigger; and
a valve assembly configured to be moved in a first direction by actuation of the trigger, the valve assembly comprising:
a first spring configured to bias the valve assembly in a second direction and to be compressed by movement of the valve assembly in the first direction; and
a second spring configured to store energy in a first phase of the movement of the valve assembly in the first direction of movement and to release the stored energy in a second phase of the movement of the valve assembly in the first direction to assist in moving the valve assembly in the first direction; and
a spray tip assembly removably coupled to the gun, the spray tip assembly comprising:
a spray tip;
a tip saddle; and
a seal element disposed, at least partially, within the tip saddle and having a top surface in contact with an exterior surface of the tip saddle, the seal element defining an inlet to the spray tip assembly and forming a seal between the gun and the spray tip assembly.

14. The fluid applicator of claim 13, wherein the spray tip assembly further comprises:
a retaining element, the tip saddle and the spray tip disposed, at least partially, within the retaining element; and
wherein the seal element further comprises a captivating wing configured to contact an inner surface of the retaining element and thereby establish a friction fit between the seal element and the retaining element.

15. The fluid applicator of claim 13, wherein the second spring is one of a compression spring or a tension spring.

16. The fluid applicator of claim 13, wherein the gun further comprises:
a spring chamber;
a valve fluid volume; and
a seal configured to fluidically seal the spring chamber from the valve fluid volume.

17. The fluid applicator of claim 16, wherein both the first spring and the second spring are disposed in in the spring chamber.

18. The fluid applicator of claim 16, wherein the first spring is disposed in the spring chamber and wherein the second spring is disposed in the valve fluid volume.

19. The fluid applicator of claim 13, wherein both the first spring and second spring are configured to contact fluid applied by the fluid applicator.

20. The fluid applicator of claim 13, wherein the second spring is in contact with the trigger.
